(19) United States
(12) Patent Application Publication
(10) Pub. No.: US 2026/0236023 A1
(43) Pub. Date: Aug. 13, 2026

(54) INFORMATION PROCESSING METHOD, COMPUTER PROGRAM PRODUCT, AND INFORMATION PROCESSING DEVICE

(71) Applicant: Panasonic Intellectual Property Management Co., Ltd., Osaka (JP)

(72) Inventors: Motoshi ANABUKI, Hyogo Ken (JP); Takumi TONOIKE, Osaka Fu (JP); Yuta SHIMOTSUMA, Osaka Fu (JP)

(73) Assignee: Panasonic Intellectual Property Management Co., Ltd., Osaka (JP)

(21) Appl. No.: 19/446,320

(22) Filed: Jan. 12, 2026

Related U.S. Application Data
(63) Continuation of application No. PCT/JP2025/004401, filed on Feb. 10, 2025.

(51) Int. Cl. G05D 1/24; G05D 1/224; G05D 107/13; G05D 109/10

(52) U.S. Cl. CPC G05D 1/24; G05D 1/2246; G05D 1/2247; G05D 2107/13; G05D 2109/10

(57) ABSTRACT

An information processing method is executed by an information processing device. The information processing method includes: receiving moving body information including a position of a moving body; and determining that the moving body is positioned at a specific position when a specific determination condition that the position of the moving body is within a specific area that includes the specific position of the moving body is satisfied.

### CROSS-REFERENCE TO RELATED APPLICATIONS

This application is a continuation of International Application No. PCT/JP2025/004401, filed on Feb. 10, 2025, the entire contents of which are incorporated herein by reference.

### FIELD

Embodiments of the present invention relate to an information processing method, a computer program product, and an information processing device.

### BACKGROUND

In recent years, automation such as transportation by an autonomous moving body such as an autonomous vehicle has been implemented. In addition, technologies for remotely controlling the moving body have been disclosed. For the technologies for remotely controlling movements, a technology for traveling a moving body toward a specific position such as a target position and allowing the moving body arriving at the specific position to execute various types of tasks is disclosed. In addition, use cases include notifying an operator of being positioned at a specific position such as a departure position or a target position, allowing a local user to execute work using a moving body positioned at a specific position, and the like.

Here, in the real space, it may be difficult for the moving body to be positioned at the specific position due to the presence of obstacles and the like. Meanwhile, the related technologies determine that the moving body is positioned at the specific position when the position of the moving body coincides with the specific position in the real space, making it difficult to execute suitable remote control support according to the conditions of the real space.

A related technology is described in Japan Patent No. 6566995.

### SUMMARY

An information processing method according to an embodiment is executed by an information processing device. The information processing method includes: receiving moving body information including a position of a moving body; and determining that the moving body is positioned at a specific position when a specific determination condition that the position of the moving body is within a specific area that includes the specific position of the moving body is satisfied.

### BRIEF DESCRIPTION OF DRAWINGS

FIG. 1 is an explanatory diagram of an example of an information processing system according to an embodiment;

FIG. 2 is a functional block diagram of an example of the information processing system according to an embodiment;

FIG. 3A is a schematic diagram of an example of a data configuration of moving body information;

FIG. 3B is a schematic diagram of an example of a data configuration of a moving body state master DB;

FIG. 3C is a schematic diagram of an example of data of a moving body information management DB;

FIG. 3D is a schematic diagram of an example of a data configuration of a target position management DB;

FIG. 3E is a schematic diagram of an example of a data configuration of a traveling path management DB;

FIG. 3F is a schematic diagram of an example of a data configuration of a task management master DB;

FIG. 3G is a schematic diagram of an example of a data configuration of a task transition management DB;

FIG. 4A is an explanatory diagram of an example of an arrival determination;

FIG. 4B is an explanatory diagram of an example of the arrival determination;

FIG. 5A is a schematic diagram of an example of a display screen;

FIG. 5B is a schematic diagram of an example of the display screen;

FIG. 5C is a schematic diagram of an example of the display screen;

FIG. 5D is a schematic diagram of an example of the display screen;

FIG. 5E is a schematic diagram of an example of the display screen;

FIG. 5F is a schematic diagram of an example of the display screen;

FIG. 6 is a sequence diagram illustrating an example of a flow of information processing executed in an information processing system 1;

FIG. 7A is a flowchart illustrating an example of a flow of information processing executed by an information processing device;

FIG. 7B is a flowchart illustrating an example of a flow of information processing executed by the information processing device;

FIG. 8A is a schematic diagram of an example of the display screen;

FIG. 8B is a schematic diagram of an example of the display screen;

FIG. 8C is a schematic diagram of an example of the display screen;

FIG. 8D is a schematic diagram of an example of the display screen;

FIG. 8E is a schematic diagram of an example of the display screen;

FIG. 8F is a schematic diagram of an example of the display screen;

FIG. 8G is a schematic diagram of an example of the display screen;

FIG. 8H is a schematic diagram of an example of the display screen;

FIG. 8I is a schematic diagram of an example of the display screen;

FIG. 8J is a schematic diagram of an example of the display screen;

FIG. 8K is a schematic diagram of an example of the display screen;

FIG. 8L is a schematic diagram of an example of the display screen;

FIG. 8M is a schematic diagram of an example of the display screen;

FIG. 8N is a schematic diagram of an example of the display screen;

FIG. 8O is a schematic diagram of an example of the display screen;

FIG. 8P is a schematic diagram of an example of the display screen;

FIG. 8Q is a schematic diagram of an example of the display screen;

FIG. 8R is a schematic diagram of an example of the display screen;

FIG. 8S is a schematic diagram of an example of the display screen;

FIG. 9A is a schematic diagram of an example of the display screen;

FIG. 9B is a schematic diagram of an example of the display screen;

FIG. 9C is a schematic diagram of an example of the display screen;

FIG. 9D is a schematic diagram of an example of the display screen;

FIG. 9E is a schematic diagram of an example of the display screen;

FIG. 9F is a schematic diagram of an example of the display screen;

FIG. 9G is a schematic diagram of an example of the display screen;

FIG. 9H is a schematic diagram of an example of the display screen;

FIG. 9I is a schematic diagram of an example of the display screen; and

FIG. 10 is a diagram illustrating a hardware configuration.

### DETAILED DESCRIPTION

Embodiments of an information processing method, an information processing program, and an information processing device will be described in detail below with reference to the accompanying drawings.

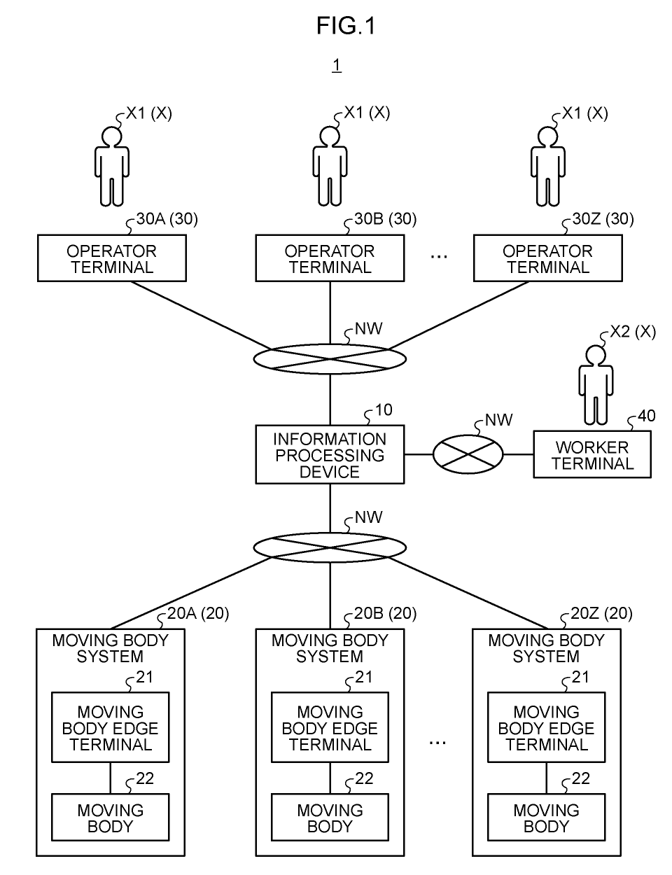

FIG. 1 is an explanatory diagram of an example of an information processing system 1 according to the present embodiment.

The information processing system 1 includes an information processing device 10, one or a plurality of moving body systems 20 (20A-20Z), one or a plurality of operator terminals 30 (30A-30Z), and one or a plurality of worker terminals 40. The information processing device 10, the moving body system 20, the operator terminal 30, and the worker terminal 40 are communicatively connected to each other via a network NW or the like.

The network NW for communicatively connecting the information processing device 10 and the moving body system 20, the network NW for communicatively connecting the information processing device 10 and the operator terminal 30, and the network NW for communicatively connecting the information processing device 10 and the worker terminal 40 may be the same network or different networks.

The information processing device 10 is an information processing device that executes management or the like of a moving body 22, the operator terminal 30, and the worker terminal 40 included in the information processing system 1. The information processing device 10 is a dedicated or general purpose computer.

The moving body system 20 includes a moving body edge terminal 21 and the moving body 22. The moving body system 20 includes one moving body edge terminal 21 and one moving body 22. The moving body edge terminal 21 and the moving body 22 are communicatively connected to each other.

The moving body 22 is targeted for remote control by an operator X1 and is capable of autonomous traveling.

By the remote control, it means a work related to remote control of the moving body 22 by the operator X1. The remote control includes at least one of remote operation of the moving body 22 and remote monitoring of the moving body 22.

For example, the moving body 22 is an autonomously traveling vehicle, an autonomously traveling robot with a moving function, an automatic guided vehicle (AGV) or the like. The autonomously traveling vehicle may be referred to as an autonomous vehicle. In the present embodiment, an arrangement will be described by way of example, in which the moving body 22 is a vehicle capable of autonomous traveling.

The moving body edge terminal 21 is an information processing device for performing communication control or the like for communicating information on the moving body 22 with the information processing device 10. In the present embodiment, an arrangement will be described by way of example, in which the moving body edge terminal 21 and the moving body 22 are configured as separate bodies and the moving body edge terminal 21 is mounted on the moving body 22. In addition, the moving body edge terminal 21 and the moving body 22 may be integrally configured.

The operator terminal 30 is an information processing device for remotely controlling the moving body 22. The operator terminal 30 is operated by the operator X1 who is responsible for the remote control of the moving body 22. The operator X1 is an example of a user X.

The worker terminal 40 is an information processing device operated by a worker X2 who executes a work using the moving body 22 or a work related to the moving body 22 in the real space. The worker terminal 40 may be, for example, a portable terminal carried around by the worker X2. The worker X2 is an example of the user X.

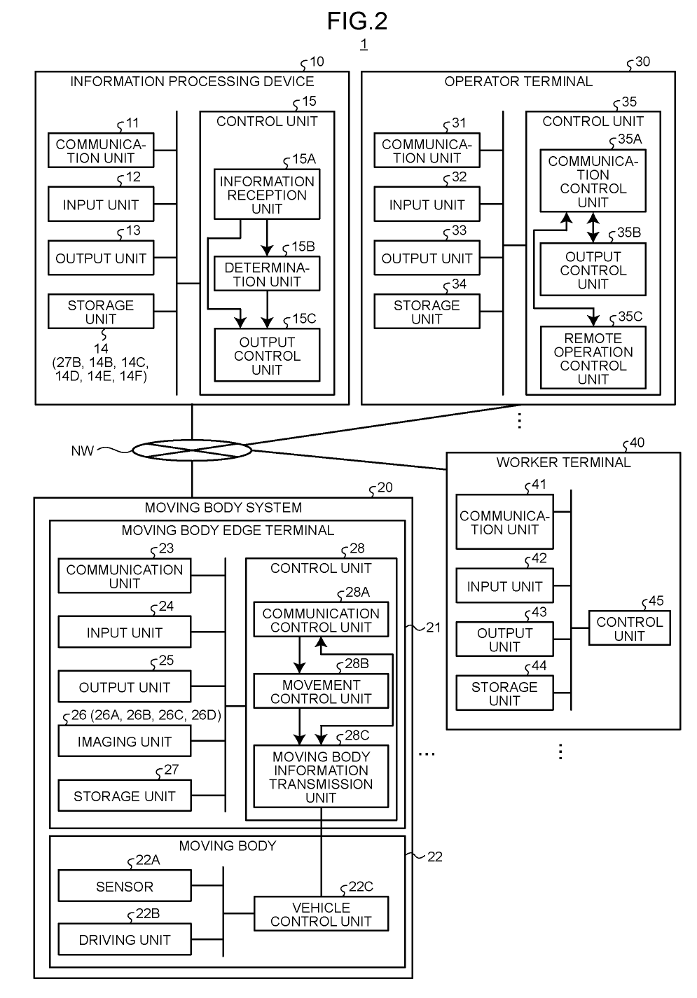

FIG. 2 is a functional block diagram of an example of the information processing system 1 according to the present embodiment.

The moving body system 20 includes the moving body edge terminal 21 and the moving body 22. The moving body edge terminal 21 and the moving body 22 are communicatively connected to each other. As described above, the moving body system 20 includes one moving body edge terminal 21 and one moving body 22. In the present embodiment, an arrangement will be described based on an assumption that the moving body system 20 includes a pair including one moving body edge terminal 21 and one moving body 22.

The moving body 22 includes a sensor 22A, a driving unit 22B, and a vehicle control unit 22C. The sensor 22A, the driving unit 22B, and the vehicle control unit 22C are communicatively connected to each other via a bus or the like.

The sensor 22A is a sensor that senses a state of the moving body 22. The sensor 22A is, for example, an internal field sensor and an external field sensor.

The internal field sensor is a sensor for obtaining inner field observation information of the moving body 22. The observation information is information such as position, speed, acceleration, steering angle, steering direction, accelerator stepping angle, vibration and the like, of the moving body 22. Specifically, the internal field sensor includes a position sensor (Global Navigation Satellite System (GNSS), Global Positioning System (GPS)). In addition, the internal field sensor includes, for example, an inertial measurement unit (IMU), an acceleration sensor, a speed sensor, a rate sensor such as a gyro sensor and the like, a rotary encoder, a steering angle sensor, a steering direction sensor, an accelerator stepping angle sensing sensor, a vibration sensor and the like. In addition, the internal field sensor also includes a sensor for detecting mode information indicating whether the moving body 22 is autonomously traveling or not, and a sensor for detecting whether the moving body 22 is stopped or not.

The external field sensor is a sensor for obtaining distance information. The distance information is information showing a distance from the moving body 22 to an object around the moving body 22.

The external field sensor may be, for example, a distance sensor. For example, the distance sensor is a millimeter wave radar, a laser sensor, a distance image sensor and the like. For example, the laser sensor is a two-dimensional laser imaging detection and ranging (LiDAR) sensor installed parallel to a horizontal surface, or a three-dimensional LiDAR sensor.

The sensor 22A sequentially senses the state of the moving body 22 along a time series, and sequentially outputs a sensing result to a control unit 28.

The driving unit 22B is a dedicated control device for a device mounted on the moving body 22 to perform driving related to the traveling of the moving body 22. The driving unit 22B includes, for example, an electronic control unit (ECU) for controlling an engine and the like, a motor driver for controlling a motor and the like. The driving unit 22B controls the driving of the device by the control of the vehicle control unit 22C.

The vehicle control unit 22C controls respective units of the moving body 22. For example, the vehicle control unit 22C controls the driving unit 22B to enable autonomous traveling of the moving body 22. The vehicle control unit 22C determines a situation around the moving body 22 based on the sensing result or the like of the sensor 22A, controls an accelerator amount, a brake amount, a steering angle and the like, and controls the driving unit 22B to enable autonomous traveling of the moving body 22.

In addition, the vehicle control unit 22C executes remote operation traveling based on remote operation instruction information received from the operator terminal 30 via the moving body edge terminal 21 and the information processing device 10. By the remote operation traveling, it means traveling according to the remote operation by the operator terminal 30. In addition, the vehicle control unit 22C may receive the remote operation instruction information from the operator terminal 30 via the information processing device 10 rather than via the moving body edge terminal 21. During remote operation traveling, the vehicle control unit 22C controls an accelerator amount, a brake amount, a steering angle and the like based on the remote operation instruction information received from the operator terminal 30, and controls the driving unit 22B so that the moving body 22 travels according to the operation instruction by the operator terminal 30.

The moving body edge terminal 21 includes a communication unit 23, an input unit 24, an output unit 25, an imaging unit 26, a storage unit 27, and the control unit 28. The communication unit 23, the input unit 24, the output unit 25, the imaging unit 26, the storage unit 27, and the control unit 28 are communicatively connected to each other via a bus or the like.

The communication unit 23 communicates with the information processing device 10 via the network NW or the like. In addition, the communication unit 23 communicates with the moving body 22 via the network NW or directly. The input unit 24 receives various types of operations by the user. The output unit 25 outputs various types of information. The output unit 25 is a display for displaying various types of information, a speaker for outputting various types of sounds and the like.

The imaging unit 26 is a camera that captures the surroundings of the moving body 22 to obtain captured video data. The captured video data will be referred to as a captured video in the following description. For example, the moving body 22 may be provided with a plurality of imaging units 26 (e.g., imaging units 26A to 26D) having different capturing directions from each other.

The storage unit 27 stores various types of data. The storage unit 27 includes, for example, a random access memory (RAM), a semiconductor memory element such as a flash memory, a hard disk, an optical disk and the like. In addition, the storage unit 27 may be a storage device provided outside the moving body edge terminal 21. In addition, the storage unit 27 may be a storage medium that stores or temporarily stores programs and various types of information downloaded via a local area network (LAN), the Internet or the like.

The control unit 28 is a computer that executes information processing in the moving body edge terminal 21.

The control unit 28 includes a communication control unit 28A, a movement control unit 28B, and a moving body information transmission unit 28C. The communication control unit 28A, the movement control unit 28B, and the moving body information transmission unit 28C are implemented by one or a plurality of processors. For example, each of the units described above may be implemented by executing a program on a processor such as a central processing unit (CPU), that is, by software.

Each of the units described above may be implemented by a processor such as a dedicated IC, that is, by hardware. Each of the units described above may be implemented by using software and hardware in parallel. When a plurality of processors are used, each processor may implement one of the respective units, or two or more of the respective units.

The communication control unit 28A controls communication with the information processing device 10.

The movement control unit 28B controls the driving unit 22B via the vehicle control unit 22C to enable autonomous traveling of the moving body 22. The movement control unit 28B determines the situation around the moving body 22 based on the sensing result or the like of the sensor 22A, controls an accelerator amount, a brake amount, a steering angle and the like, and controls the driving unit 22B to enable autonomous traveling of the moving body 22, thereby making the moving body 22 autonomously travel.

In addition, the movement control unit 28B executes remote operation traveling based on the remote operation information received from the operator terminal 30 via the information processing device 10. By the remote operation traveling, it means traveling according to the remote operation by the operator terminal 30. During the remote operation traveling, the movement control unit 28B controls an accelerator amount, a brake amount, a steering angle and the like based on the remote operation information received from the operator terminal 30, and controls the driving unit 22B so that the moving body 22 travels according to the operation instruction by the operator terminal 30.

The moving body information transmission unit 28C transmits moving body information to the information processing device 10 via the communication control unit 28A and the communication unit 23.

The moving body information is information on the traveling environment of the moving body 22. The moving body information includes a moving body state and a position of the moving body 22. The moving body information may include the moving body state, the position of the moving body 22, the sensing result of the sensor 22A, the captured video taken by the imaging unit 26, and an analysis result of the traveling environment.

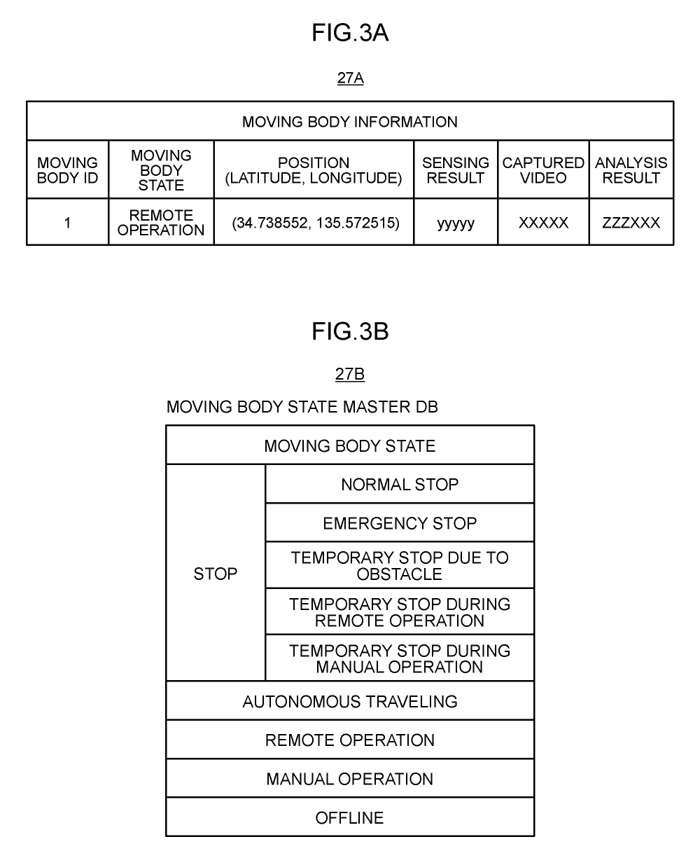

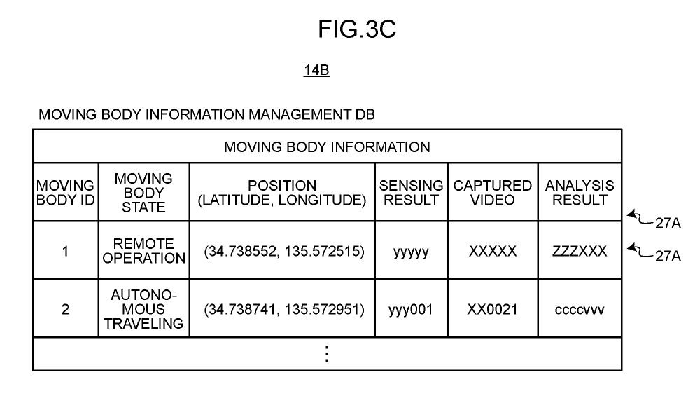

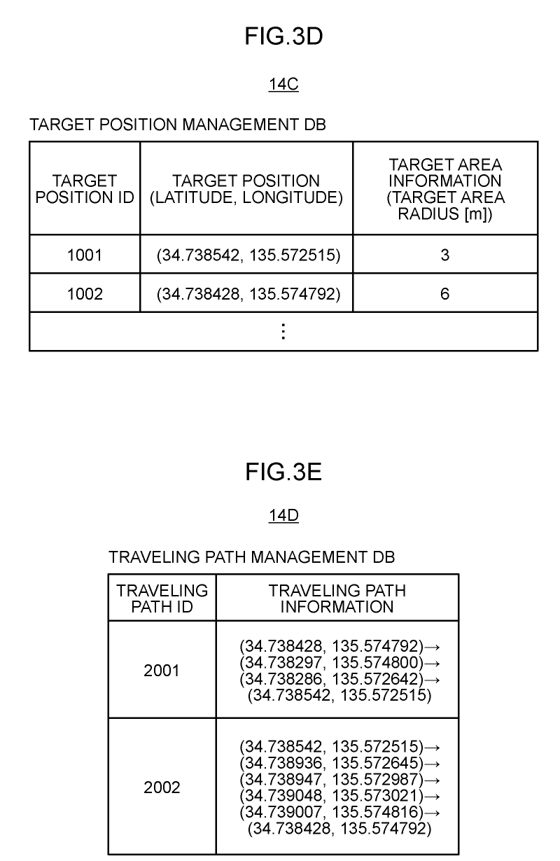

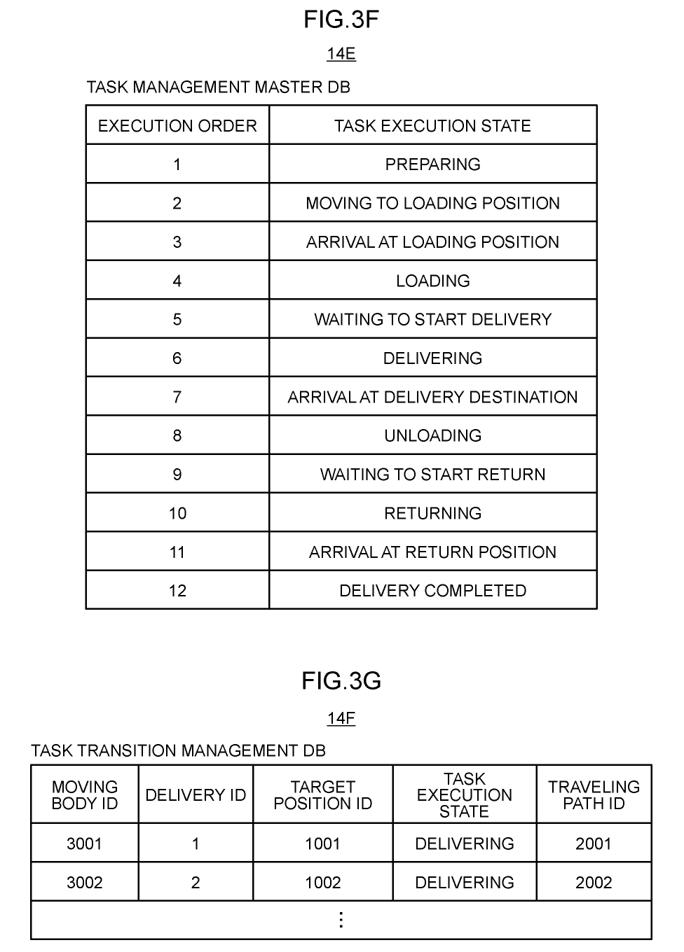

FIG. 3A is a schematic diagram of an example of a data configuration of moving body information 27A.

The moving body information 27A includes a moving body ID that is identification information of the moving body 22, the moving body state, the position of the moving body 22, the sensing result, the captured video, and the analysis result.

The moving body state is information indicating the state of the moving body 22. The moving body information transmission unit 28C analyzes the state of the moving body 22 by using the sensing result, the captured video, the position of the moving body 22, the analysis result or the like.

FIG. 3B is a schematic diagram of a moving body state master DB 27B. The moving body state master DB 27B is a database that predefines the types of moving body states that the moving body 22 may have. The data format of the moving body state master DB 27B is not limited to the database.

The moving body state may include "stop", "autonomous traveling", "remote operation", "manual operation", and "offline". The state "stop" includes "normal stop", "emergency stop", "temporary stop due to obstacle", "temporary stop during remote operation", and "temporary stop during manual operation".

The moving body state "stop" indicates a state in which the moving body 22 is stopped and not moving. The moving body state "autonomous traveling" indicates that the moving body 22 is traveling autonomously. The moving body state "remote operation" indicates a state in which the moving body 22 is remotely operated by the operator X1. The moving body state "manual operation" indicates a state in which the moving body 22 is operated directly by the worker X2 or the like by a manual operation. The moving body state "offline" indicates that communication between the moving body 22 and the information processing device 10 is cut off.

The moving body state "normal stop" indicates that the moving body 22 is in a normal stopped condition. By the normal stop, it means a normal stop other than the emergency stop, the temporary stop due to obstacle, the temporary stop during remote operation, and the temporary stop during manual operation. It means a stop due to arrival at a preset target position or near the target position. In the case of the moving body state "normal stop", the moving body 22 does not automatically start traveling.

The moving body state "emergency stop" indicates that the moving body 22 is stopped at a deceleration acceleration of a predetermined acceleration or higher due to an occurrence of a predetermined emergency event. The moving body state "temporary stop due to obstacle" indicates a state in which the moving body 22 is temporarily stopped due to detection of an obstacle. In the case of the moving body state "temporary stop due to obstacle", the moving body 22 automatically resumes traveling when the obstacle is not sensed. The moving body state "temporary stop during remote operation" indicates a state in which the moving body 22 is temporarily stopped by the remote operation by the operator X1. In the case of the moving body state "temporary stop during remote operation", the moving body 22 resumes traveling by a remote operation by the operator X1. The moving body state "temporary stop during manual operation" indicates the stopping of the moving body 22 while the user X such as the worker X2 is manually operating the moving body 22. In the case of the moving body state "temporary stop during manual operation", the moving body 22 resumes traveling by the manual operation of the user X.

Using the sensing result, the captured video, the position of the moving body 22, the analysis result or the like, the moving body information transmission unit 28C may derive which of the moving body states registered in the moving body state master DB 27B corresponds to the state of the moving body 22.

The moving body information transmission unit 28C derives the position of the moving body 22 by acquiring the position of the moving body 22 in the real space, which is included in the sensing result of the sensor 22A. The position of the moving body 22 is indicated by latitude and longitude.

The moving body information transmission unit 28C analyzes the captured video obtained by the imaging unit 26 using a known image processing method or the like to derive an analysis result. In addition, the moving body information transmission unit 28C analyzes at least one of the captured video, the sensing result of the sensor 22A, and map data by a known analysis method to derive the analysis result of the traveling environment of the moving body 22.

The analysis result may include information on the environment around the moving body 22. For example, the analysis result includes information indicating an obstacle present around the moving body 22, a traveling area of the moving body 22, a situation of the object around the moving body 22 and the like. The information indicating the obstacle present around the moving body 22 includes information indicating a type of the obstacle, a size of the obstacle, a relative position, a relative distance, a relative speed, and the like of the obstacle with respect to the moving body 22. The information indicating the traveling area of the moving body 22 includes, for example, information indicating a situation of the road on which the moving body 22 is traveling. The road situation may include a type of a traveling path, information on traffic signs such as crosswalks and traffic lights present around the traveling path, a congestion situation of the roads and the like. The situation of the object around the moving body 22 is information on the number of objects present around the moving body 22, a type of the object, whether the object is in contact with the moving body 22, and information indicating the relative position and relative distance of the object with respect to the moving body 22 and the like. The object is a person, for example. The type of the object may include, for example, gender of the person, and age of the person. In addition, the type of the object may further include behavioral information indicating a behavior of the person such as a parent holding a child, taking a picture, or visually checking an advertisement. For example, the age of the person may be estimated by a known method from the captured video.

The moving body information transmission unit 28C transmits the moving body information 27A including the moving body ID of the moving body 22 mounted on the moving body information transmission unit 28C, the derived moving body state, the position of the moving body 22, the sensing result, the captured video, and the analysis result to the information processing device 10. The moving body information transmission unit 28C repeatedly executes the derivation and transmission of the moving body information 27A to the information processing device 10 at each predetermined timing. The predetermined timing is, for example, a few seconds or the like, but is not limited thereto. The predetermined timing may be appropriately changed by the operation instruction or the like to the input unit 24 by the user X.

Turning back to FIG. 2, the description continues.

Next, the worker terminal 40 will be described.

The worker terminal 40 includes a communication unit 41, an input unit 42, an output unit 43, a storage unit 44, and a control unit 45. The communication unit 41, the input unit 42, the output unit 43, the storage unit 44, and the control unit 45 are communicatively connected to each other via a bus or the like.

The communication unit 41 communicates with the information processing device 10 via the network NW or the like. The input unit 42 receives various types of operations by the worker X2. The output unit 43 outputs various types of information. The output unit 43 is a display for displaying various types of information, a speaker for outputting various types of sounds and the like. The input unit 42 and the output unit 43 may be a touch panel integrally configured with the input unit 42 and the output unit 43.

The storage unit 44 stores various types of data. The storage unit 44 is, for example, a RAM, a semiconductor memory element such as a flash memory, a hard disk, an optical disk and the like. The storage unit 44 may be a storage device provided outside the worker terminal 40. In addition, the storage unit 44 may be a storage medium that stores or temporarily stores programs and various types of information downloaded via a LAN, the Internet or the like.

The control unit 45 is a computer that executes information processing in the worker terminal 40. The control unit 45 may be implemented by executing a program on a processor such as a CPU, that is, by software.

Next, the operator terminal 30 will be described.

The operator terminal 30 includes a communication unit 31, an input unit 32, an output unit 33, a storage unit 34, and a control unit 35. The communication unit 31, the input unit 32, the output unit 33, the storage unit 34, and the control unit 35 are communicatively connected to each other via a bus or the like.

The communication unit 31 communicates with the information processing device 10 via the network NW or the like. The input unit 32 receives various types of operations by the operator X1. The output unit 33 outputs various types of information. The output unit 33 is a display for displaying various types of information, a speaker for outputting various types of sounds and the like.

The storage unit 34 stores various types of data. The storage unit 34 is, for example, a RAM, a semiconductor memory element such as a flash memory, a hard disk, an optical disk and the like. In addition, the storage unit 34 may be a storage device provided outside the operator terminal 30. In addition, the storage unit 34 may be a storage medium that stores or temporarily stores programs and various types of information downloaded via a LAN, the Internet or the like.

The control unit 35 is a computer that executes information processing in the operator terminal 30.

The control unit 35 includes a communication control unit 35A, an output control unit 35B, and a remote operation control unit 35C. The communication control unit 35A, the output control unit 35B, and the remote operation control unit 35C are implemented by one or a plurality of processors. For example, each of the units described above may be implemented by executing a program on a processor such as a CPU, that is, by software.

Each of the units described above may be implemented by a processor such as a dedicated IC, that is, by hardware. Each of the units described above may be implemented by using software and hardware in parallel. When a plurality of processors are used, each processor may implement one of the respective units, or two or more of the respective units.

In addition, at least one of the respective units described above included in the control unit 35 may be mounted on an external information processing device communicatively connected to the operator terminal 30 via the network NW or the like.

The communication control unit 35A controls communication with the information processing device 10.

The output control unit 35B outputs to the output unit 33 a display screen corresponding to display screen information received from the information processing device 10 via the communication control unit 35A and the communication unit 31.

The display screen information is information for displaying a display screen displayed by the operator X1 during the remote control of the moving body 22 on the output unit 33 of the operator terminal 30.

The display screen is a screen for displaying various types of information to the operator X1 and receiving input or setting from the operator X1. Details of the display screen information and the display screen will be described below.

The output control unit 35B displays the display screen corresponding to the display screen information received from the information processing device 10 on a display of the output unit 33. When the display screen information includes a captured video around the moving body 22 taken by the moving body system 20, the output control unit 35B displays the captured video on the output unit 33. The captured video of the moving body 22 refers to a captured video of the surroundings of the moving body 22, which is taken by the imaging unit 26 that captures the surroundings of the moving body 22, in which the imaging unit 26 is included in the moving body edge terminal 21 communicatively connected to the moving body 22. The operator X1 visually checks a display screen including the captured video displayed on the output unit 33, and thus is able to monitor and remotely operate the moving body 22.

The remote operation control unit 35C remotely controls the moving body 22 according to operations on the input unit 32 by the operator X1. For example, the remote operation control unit 35C transmits, to the information processing device 10, the remote operation instruction information corresponding to an operation instruction to the moving body 22 input according to the operations on the input unit 32 by the operator X1, together with the moving body ID (identification) of the moving body 22. The moving body ID is identification information of the moving body 22. The information processing device 10 transmits the remote operation instruction information to the moving body 22 identified by the moving body ID. Based on the remote operation instruction information, the vehicle control unit 22C of the moving body 22 controls the driving unit 22B to move the moving body 22 according to the remote operation by the operator X1. Therefore, the moving body 22 is remotely operated by the operator X1 operating the operator terminal 30.

Next, the information processing device 10 will be described.

The information processing device 10 includes a communication unit 11, an input unit 12, an output unit 13, a storage unit 14, and a control unit 15. The communication unit 11, the input unit 12, the output unit 13, the storage unit 14, and the control unit 15 are communicatively connected to each other via a bus or the like.

The communication unit 11 communicates with the moving body system 20, the operator terminal 30, and the worker terminal 40 via the network NW or the like. The input unit 12 receives various types of operations by the user. The output unit 13 outputs various types of information. The output unit 13 is a display for displaying various types of information, a speaker for outputting various types of sounds and the like.

The storage unit 14 stores various types of data. The storage unit 14 is, for example, a RAM, a semiconductor memory element such as a flash memory, a hard disk, an optical disk and the like. In addition, the storage unit 14 may be a storage device provided outside the information processing device 10. In addition, the storage unit 14 may be a storage medium that stores or temporarily stores programs and various types of information downloaded via a LAN, the Internet or the like. In addition, at least a part of the information stored in the storage unit 14 may be stored in a storage device such as an external server device communicatively connected to the information processing device 10.

In the present embodiment, the storage unit 14 stores the moving body state master DB 27B, a moving body information management DB 14B, a target position management DB 14C, a traveling path management DB 14D, a task management master DB 14E, a task transition management DB 14F and the like.

FIG. 3C is a schematic diagram of an example of data of the moving body information management DB 14B.

The moving body information management DB 14B is a database for managing each piece of the moving body information 27A of the moving body 22 included in the information processing system 1. The data configuration of the moving body information management DB 14B is not limited to the database.

The control unit 15, which will be described below, sequentially stores the received moving body information 27A in the moving body information management DB 14B in association with reception time each time the moving body information 27A is received from the moving body 22. Therefore, the moving body information management DB 14B is sequentially updated.

FIG. 3D is a schematic diagram of an example of a data configuration of the target position management DB 14C.

The target position management DB 14C is a database for managing a list of target positions of each of the moving bodies 22 included in the information processing system 1. The target position management DB 14C is a database in which a target position ID, a target position, and target area information are associated with each other. The data configuration of the target position management DB 14C is not limited to the database.

The target position ID is identification information of the target position.

The target position is an example of a specific position.

The specific position is one point indicated by latitude and longitude in the real space. In the present embodiment, an arrangement will be described by way of example, in which the specific position is the target position.

The target position is position information of a point that is the target of travel of the moving body 22. The target position is indicated by latitude and longitude in the real space. That is, the target position is one point indicated by latitude and longitude.

The target area is an example of the specific area.

The specific area is an area that includes the specific position. That is, the specific position is a point within the specific area that occupies a part of the specific area. In the present embodiment, an arrangement will be described by way of example, in which the specific area is the target area.

The target area is an area that includes the target position of the moving body 22. The target area is a wider range of area than the target position. That is, the target position is a point within the target area that occupies a part of the target area.

The target area may be, for example, a circular area having a predetermined radius centered at the target position, an area surrounding a target object disposed at the target position, and the like. FIG. 3D illustrates, as an example, an arrangement in which the target area is a circular area centered at a corresponding target position, and the target area information is indicated by a target area radius which is the radius of the circle centered at the corresponding target position.

The target position management DB 14C is preset and stored in the storage unit 14 in advance. The target position management DB 14C may be appropriately updated by an operation instruction or the like by the operator X1 or the user X managing the information processing system 1.

FIG. 3E is a schematic diagram illustrating an example of a data configuration of the traveling path management DB 14D.

The traveling path management DB 14D is a database for managing a traveling path of the moving body 22. The traveling path management DB 14D is a database in which a traveling path ID being identification information of a traveling path is associated with the traveling path information. The data format of the traveling path management DB 14D is not limited to the database.

The traveling path information is information indicating the traveling path of the moving body 22. FIG. 3E illustrates, as an example, an arrangement in which the traveling path information is indicated by latitude and longitude indicating each of the target positions of the moving body 22 and points that the moving body 22 passes through, and arrows connecting these target positions and points in the traveling direction. In addition, in the traveling path information, the latitude and longitude indicating the target position of the moving body 22 are provided with flag information indicating them to be the target position.

The traveling path management DB 14D is preset and stored in the storage unit 14 in advance. The traveling path management DB 14D may be appropriately updated by an operation instruction or the like by the operator X1 or the user X managing the information processing system 1.

FIG. 3F is a schematic diagram of an example of a data configuration of the task management master DB 14E. The task management master DB 14E registers the execution order of tasks executed by the moving body 22 and the execution states thereof in association with each other. In the present embodiment, an arrangement will be described by way of example, in which a series of tasks including one or a plurality of tasks executed by the moving body 22 are delivery tasks related to the delivery of object by the moving body 22. Therefore, in the task management master DB 14E, the execution states of a plurality of tasks included in the delivery tasks of the object by the moving body 22 are registered in the execution order in advance.

In addition, the task may further include a set of sub-tasks. For example, the delivery task may include a sub-task specifying more detailed behavior such as "road A traveling", "crosswalk B traveling", and "road C traveling". In addition, for example, the delivery task may include a sub-task specifying more detailed behavior such as "corridor A traveling", "moving to the third floor by elevator B", and "corridor C traveling".

In addition, the series of tasks executed by the moving body 22 is not limited to the delivery tasks.

FIG. 3G is a schematic diagram of an example of a data configuration of the task transition management DB 14F. The task transition management DB 14F is a database for managing the transition of a task executed by each moving body 22 for each delivery task. The task transition management DB 14F is a database in which a moving body ID, a delivery ID, a target position ID, a task execution state, and a traveling path ID are associated with each other. The data format of the task transition management DB 14F is not limited to the database.

The delivery ID is identification information of a delivery task being executed or to be executed on the moving body 22 identified by the corresponding moving body ID. The target position ID in the task transition management DB 14F is a target position ID of the next target position of the corresponding moving body 22. The task execution state in the task transition management DB 14F indicates a current task execution state of the moving body 22 identified by the corresponding moving body ID. The traveling path ID in the task transition management DB 14F is identification information of the traveling path of the moving body 22 identified by the corresponding moving body ID.

The control unit 15 to be described below updates the task execution state indicating a task being executed by the moving body 22, sequentially following the execution order registered in the task management master DB 14E from the top to the bottom, in response to changes in the situation of the moving body 22. Therefore, the task transition management DB 14F is updated by the control unit 15 to be described below.

Turning back to FIG. 2, the description continues.

The control unit 15 is a computer that executes information processing in the information processing device 10.

The control unit 15 includes an information reception unit 15A, a determination unit 15B, and an output control unit 15C. The information reception unit 15A, the determination unit 15B, and the output control unit 15C are implemented by one or a plurality of processors. For example, each of the units described above may be implemented by executing a program on a processor such as a CPU, that is, by software.

Each of the units described above may be implemented by a processor such as a dedicated IC, that is, by hardware. Each of the units described above may be implemented by using software and hardware in parallel. When a plurality of processors are used, each processor may implement one of the respective units, or two or more of the respective units. In addition, at least one of respective units described above included in the information processing device 10 may be mounted on an external information processing device communicatively connected to the information processing device 10 via the network NW or the like.

The information reception unit 15A receives information from each of the moving body 22, the operator terminal 30, and the worker terminal 40 via the communication unit 11.

In detail, upon receiving the remote operation information from the operator terminal 30, the information reception unit 15A transmits the remote operation information to the moving body 22 identified by the moving body ID included in the remote operation information. In addition, the information reception unit 15A receives the moving body information 27A from the moving body 22.

When a specific determination condition is satisfied, the determination unit 15B determines that the moving body 22 is positioned at the specific position. The specific determination condition is a determination condition for determining that the position of the moving body 22 is the specific position. In detail, the specific determination condition indicates that the position of the moving body 22 is within the specific area that includes the specific position of the moving body 22.

As described above, in the present embodiment, a case in which the specific position is the target position and the specific area is the target area will be described as an example. In the present embodiment, the specific determination condition will be described as an arrival determination condition. That is, the arrival determination condition is an example of the specific determination condition. The arrival determination condition indicates that the position of the moving body 22 is within the target area that includes the target position of the moving body 22.

In the present embodiment, when the arrival determination condition is satisfied, the determination unit 15B determines that the moving body 22 is positioned at the target position. That is, in this case, the determination unit 15B determines that the moving body 22 has arrived at the target position.

The determination unit 15B specifies the position of the moving body 22 indicated by the latest moving body information 27A received from the moving body 22. In addition, the determination unit 15B reads, from the target position management DB 14C, the target area information corresponding to the target position ID associated with the moving body ID of the moving body 22 in the task transition management DB 14F. Then, the determination unit 15B determines whether a position P of a specific moving body 22 is within the target area indicated by the read target area information, and determines whether the position of the moving body 22 is within the target area that includes the target position of the moving body 22.

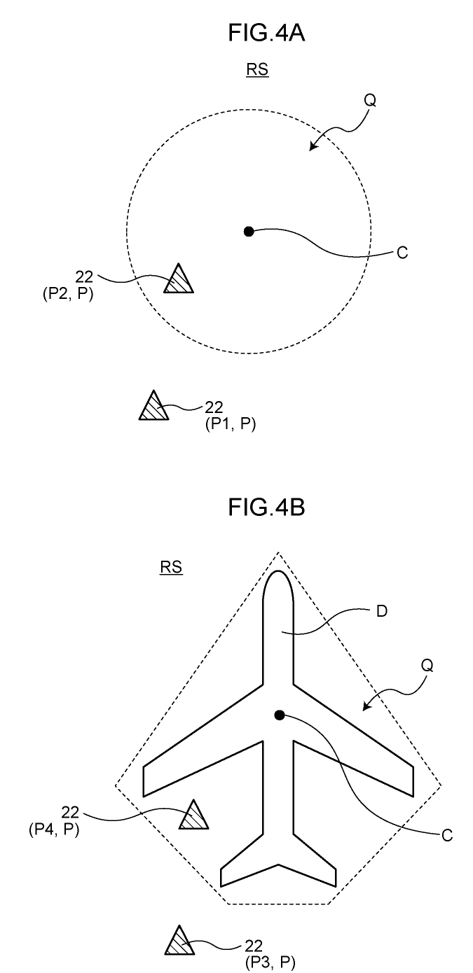

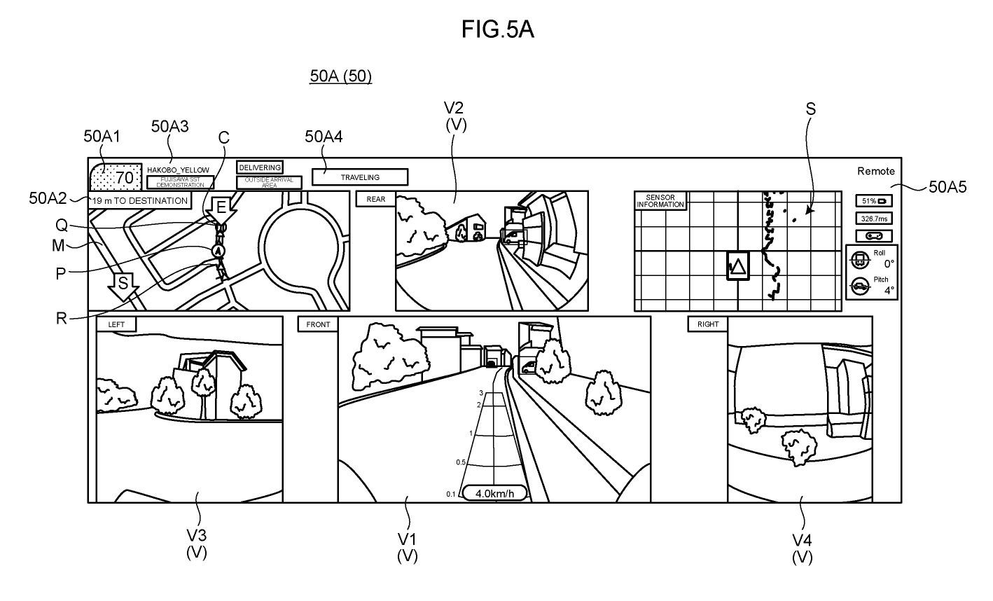

FIGS. 4A and 4B are explanatory diagrams of an example of arrival determination by the determination unit 15B. FIGS. 4A and 4B schematically illustrate a target area Q in a real space RS.

FIG. 4A illustrates, as an example, a case in which the target area Q is a circular area having a radius (a target area radius) centered at a target position C. When the position P of the moving body 22 is a position P1 outside the target area Q, the determination unit 15B determines that the moving body 22 has not arrived at the target position C. In addition, when the position P of the moving body 22 is a position P2 inside the target area Q, the determination unit 15B determines that the moving body 22 has arrived at the target position C. The positions P1 and P2 are examples of the position P of the moving body 22.

FIG. 4B illustrates, as an example, a case in which the target area Q is an area that surrounds a target object D provided at the target position C. In this case, the target position C is a position on the target object D. The target object D is an object present in the real space RS. FIG. 4B illustrates, as an example, an arrangement in which the target object D is an aircraft in a state of being stopped at an aerodrome. In addition, an arrangement is illustrated by way of example, in which the target area Q is a polygonal shape connecting end points of an outline of the aircraft which is the target object D. The target area Q in this shape and a range of the aircraft may be referred to as an aircraft safety zone. By the aircraft safety zone, it means an area where an element around the aircraft, which is the movable target object D, is required to be positioned with care for their own safety.

When the position P of the moving body 22 is a position P3 outside the target area Q, the determination unit 15B determines that the moving body 22 has not arrived at the target position C. In addition, when the position P of the moving body 22 is a position P4 inside the target area Q, the determination unit 15B determines that the moving body 22 has arrived at the target position C. The positions P3 and P4 are examples of the position P of the moving body 22.

That is, even when the position P of the moving body 22 does not coincide with the target position C, the determination unit 15B determines that the moving body 22 has arrived at the target position C when the position P of the moving body 22 is within the target area Q.

The arrival determination condition may indicate that the position of the moving body 22 is within the target area Q that includes the target position C of the moving body 22, and that the current moving body state of the moving body 22 is "stop". In addition, the arrival determination condition may indicate that the position of the moving body 22 is within the target area Q that includes the target position C of the moving body 22, and that the current moving body state of the moving body 22 is "normal stop". The determination unit 15B determines whether the moving body state included in the latest moving body information 27A received from the moving body 22 is "stop" or "normal stop" to determine whether the moving body state of the moving body 22 is "stop" or "normal stop".

In addition, when the arrival determination condition is satisfied and a temporary disabling instruction for arrival determination is received from the operator terminal 30 via the display screen, the determination unit 15B may determine that the moving body 22 has not arrived at the target position C. That is, even when the position P of the moving body 22 is within the target area Q, when the determination unit 15B receives a temporary disabling instruction for arrival determination from the operator terminal 30 according to the operation instruction by the operator X1, the determination unit 15B may determine that the moving body 22 has not arrived at the target position C.

In addition, when the determination unit 15B receives a forced arrival determination instruction from the operator terminal 30 via the display screen, the determination unit 15B may determine that the moving body 22 has arrived at the target position C. That is, even when the position P of the moving body 22 is outside the target area Q, when the determination unit 15B receives a forced arrival determination instruction from the operator terminal 30 according to the operation instruction by the operator X1, the determination unit 15B may determine that the moving body 22 has arrived at the target position C.

In addition, after determining that the arrival determination condition is satisfied, when the determination unit 15B receives an arrival re-determination instruction from the operator terminal 30 via the display screen, the determination unit 15B may re-determine whether the moving body 22 has arrived at the target position C.

Turning back to FIG. 2, the description continues.

The output control unit 15C outputs a display screen indicating the positional relationship between the target area Q and the moving body 22 to the operator terminal 30 of the operator X1 who is remotely controlling the moving body 22.

In detail, the output control unit 15C outputs display screen information, including the moving body information 27A received from the moving body 22, to the operator terminal 30 being used by the operator X1. As described above, the moving body information 27A includes the position P of the moving body 22, the sensing result, the captured video, the analysis result and the like. In addition, the display screen information includes information such as the target position C of the moving body 22, the target area Q, a traveling path R, the map data indicating a traveling environment of the real space RS where the moving body 22 is traveling.

In detail, the output control unit 15C generates display screen information including the moving body information 27A; the target position ID, the task execution state, and the traveling path ID corresponding to the moving body ID included in the moving body information 27A from the task transition management DB 14F; the target position and the target area information corresponding to the target position ID from the target position management DB 14C; the traveling path information corresponding to the traveling path ID from the traveling path management DB 14D; and the map data. Then, the output control unit 15C outputs the generated display screen information to the operator terminal 30.

The output control unit 35B of the operator terminal 30 receiving the display screen information outputs a display screen indicated by the display screen information to the output unit 33. Therefore, the output control unit 15C of the information processing device 10 outputs the display screen indicated by the display screen information to the output unit 33 of the operator terminal 30.

The operator X1 is able to perform remote control such as remote operation and remote monitoring of the moving body 22 by operating the input unit 32 while referring to the display screen displayed on the output unit 33 of the operator terminal 30.

In addition, when the determination unit 15B determines that the moving body 22 has arrived at the target position C, the output control unit 15C outputs, to at least one of the operator terminal 30 and the worker terminal 40, arrival information indicating that the moving body 22 has arrived at the target position C. The arrival information is an example of information that indicates that the moving body 22 is positioned at the specific position.

Then, the output control unit 15C updates the task execution state in the task transition management DB 14F corresponding to the moving body ID of the moving body 22, which is determined to have arrived at the target position C, to the task execution state that is next in the execution order after the current task execution state in the task management master DB 14E.

In addition, the output control unit 15C may output warning information to at least one of the operator terminal 30 and the worker terminal 40 when the position P of the moving body 22 is within the target area Q but the moving body state of the moving body 22 is a state indicating a movement, such as autonomous traveling or the like.

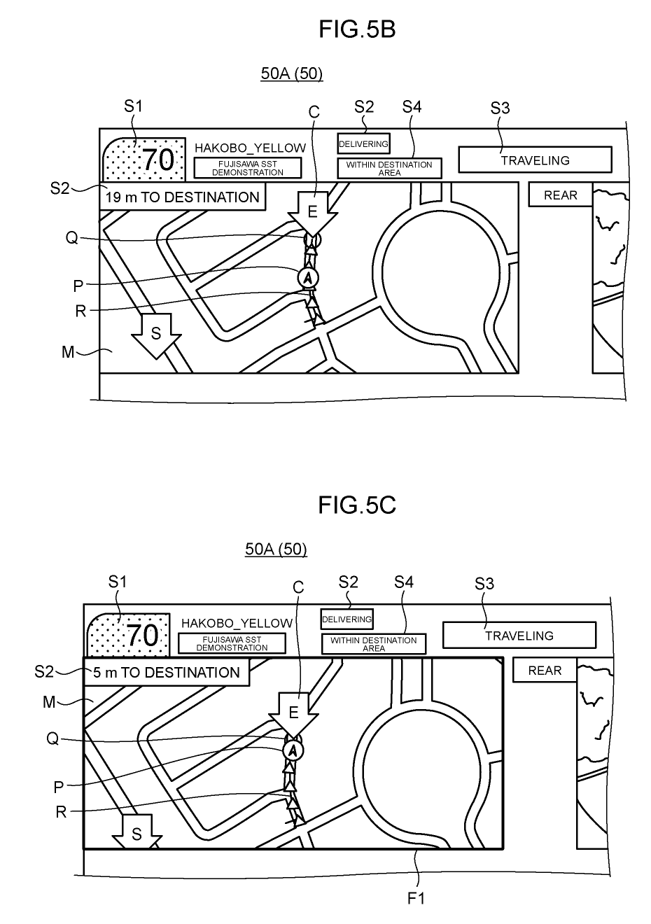

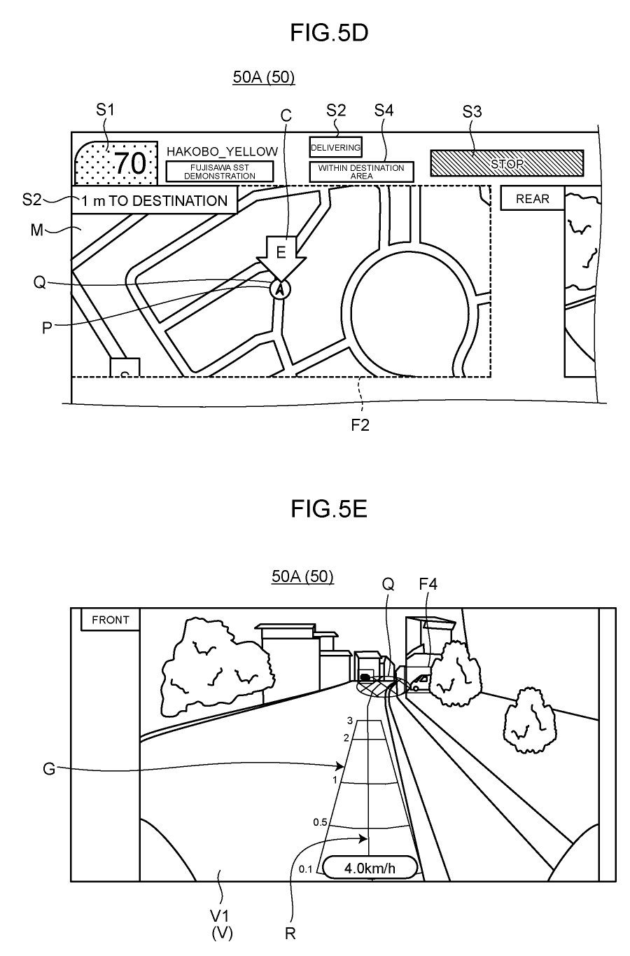

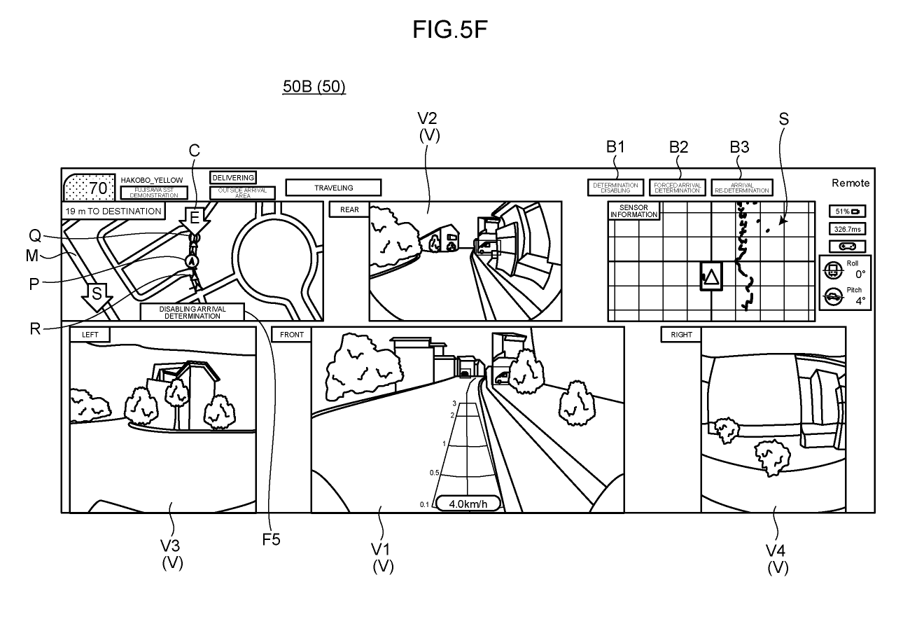

FIG. 5A is a schematic diagram of an example of a display screen 50A. The display screen 50A is an example of a display screen 50 displayed on the output unit 33 of the operator terminal 30.

Images indicating each of the target position C, the position P of the moving body 22, the target area Q, and the traveling path R are superimposed on a map image M of the map data on the display screen 50A. That is, on the display screen 50A, the information indicating the positional relationship between the position P of the moving body 22, the target position C, and the target area Q are displayed. In addition, on the display screen 50A, a left video V3, a front video V1, a right video V4, and a rear video V2 taken by the imaging unit 26 of the moving body 22 are displayed. The left video V3 is a video V from the left side of the moving body 22. The front video V1 is a video V from ahead of the moving body 22, and the right video V4 is a video V from the right side of the moving body 22. The rear video V2 is a video V from behind the moving body 22.

In addition, the display screen 50A may include a sensing result S included in the moving body information 27A. The output control unit 35B displays, for example, an image indicating the positional relationship between various types of objects present around the moving body 22 and the moving body 22, which is indicated by the sensing result S.

In addition, the display screen 50A includes identification information 50A1 of the moving body 22, remaining distance information 50A2 indicating a remaining distance from the position P of the moving body 22 to the target position C, a task execution state 50A3 of the moving body 22, a moving body state 50A4 of the moving body 22, and sensor-related information 50A5.

The sensor-related information is information indicating the sensing result by the sensor 22A. For example, when the moving body 22 is an electric vehicle, the sensor-related information includes information indicating a remaining battery level, a communication speed of the moving body system 20, whether an operation terminal for directly operating the moving body 22 is connected to the moving body 22, a posture of the moving body 22 and the like. The operation terminal for directly operating the moving body 22 may be referred to as a remote control. The posture of the moving body 22 is indicated by, for example, a roll, a pitch, a yaw and the like.

The output control unit 15C of the information processing device 10 may output display screen information including the above information to the operator terminal 30. The output control unit 35B of the operator terminal 30 may display, on the output unit 33, the display screen 50A indicated by the display screen information including the above information.

FIGS. 5B to 5D are enlarged schematic diagrams of an example of a portion of the display screen 50A illustrated in FIG. 5A.

FIG. 5B is an example of the display screen 50A displayed on the output unit 33 of the operator terminal 30 when the position P of the moving body 22 is outside the target area Q.

The display screen 50A includes identification information S1 of the moving body 22, a task S2 currently executed by the moving body 22, a moving body state S3 of the moving body 22, information S4 indicating the positional relationship between the position P of the moving body 22 and the target area Q, and remaining distance information H indicating the remaining distance from the position of the moving body 22 to the target position C. The output control unit 15C of the information processing device 10 may output display image information including the above information to the operator terminal 30.

In addition, as illustrated in FIG. 5B, on the display screen 50A, images indicating the position P of the moving body 22, the traveling path R of the moving body 22, the target position C of the moving body 22, and the target area Q of the moving body 22 are superimposed on the map image M. The output control unit 35B places and displays an image indicating the position P of the moving body 22 at the position P of the moving body 22 in the map image M. In addition, the output control unit 35B places and displays an image indicating each of the target position C and the target area Q on the map image M at a position corresponding to each of the target position C and the target area Q of the moving body 22. Therefore, on the display screen 50A illustrated in FIG. 5B, it is displayed that the position P of the moving body 22 is positioned outside the target area Q.

FIG. 5C is an example of the display screen 50A displayed on the output unit 33 of the operator terminal 30 when the position P of the moving body 22 is inside the target area Q.

As illustrated in FIG. 5C, on the display screen 50A, images indicating the position P of the moving body 22, the traveling path R of the moving body 22, the target position C of the moving body 22, and the target area Q of the moving body 22 are superimposed on the map image M. The output control unit 35B places and displays an image indicating the position P of the moving body 22 at the position P of the moving body 22 in the map image M. In addition, the output control unit 35B places and displays an image indicating each of the target position C and the target area Q on the map image M at a position corresponding to each of the target position C and the target area Q of the moving body 22. Therefore, on a display screen 50A illustrated in FIG. 5C, it is displayed that the position P of the moving body 22 is positioned inside the target area Q.

In addition, the output control unit 15C of the information processing device 10 preferably outputs the display screen 50 in a first display form to the operator terminal 30 when the position P of the moving body 22 is within the target area Q, and outputs the display screen 50 in a second display form to the operator terminal 30 when the position P of the moving body 22 is outside the target area Q. That is, the output control unit 15C may output, to the operator terminal 30, display screen information including a display instruction to display in different display forms depending on whether the position P of the moving body 22 is within the target area Q or the position P of the moving body 22 is outside the target area Q. In addition, when the position P of the moving body 22 included in the display screen information received from the information processing device 10 is within the target area Q, the output control unit 35B of the operator terminal 30 may output, to the output unit 33, a display screen in a different display form than when the position of the moving body 22 is outside the target area Q.

For example, it is assumed that the position P of the moving body 22 is positioned inside the target area Q (see FIG. 5C). The output control unit 35B displays a display frame F1 which was not displayed when the position P of the moving body 22 is positioned outside the target area Q (see FIG. 5B). In addition, the output control unit 35B may display different display forms between when the position P of the moving body 22 is within the target area Q and when the position P of the moving body 22 is outside the target area Q, and the method for changing the display form is not limited to the presence or absence of the display frame F1.

FIG. 5D illustrates an example of the display screen 50A displayed on the output unit 33 of the operator terminal 30 when the position P of the moving body 22 is positioned inside the target area Q, the moving body 22 is determined to have arrived at the target position C by the information processing device 10, and the operator terminal 30 receives the arrival information.

A scene is assumed in which the communication control unit 35A of the operator terminal 30 receives the arrival information from the information processing device 10. In this case, the arrival information serves as a display instruction to display in a different display form. When the arrival information is received, the output control unit 35B of the operator terminal 30 outputs the display screen 50 in a third display form to the output unit 33.

As illustrated in FIG. 5D, on the display screen 50A, images indicating the position P of the moving body 22, the traveling path R of the moving body 22, the target position C of the moving body 22, and the target area Q of the moving body 22 are superimposed on the map image M. The output control unit 35B places and displays an image indicating the position P of the moving body 22 at the position P of the moving body 22 in the map image M. In addition, the output control unit 35B places and displays an image indicating each of the target position C and the target area Q on the map image M at a position corresponding to each of the target position C and the target area Q of the moving body 22. Therefore, in the state illustrated in FIG. 5C, it is displayed that the position P of the moving body 22 is positioned inside the target area Q.

In addition, when the output control unit 15C receives the arrival information, the output control unit 15C displays the display area of the moving body 22 identified by the moving body ID included in the received arrival information in a display form different from before the arrival determination. For example, when the output control unit 35B receives the arrival information indicating that the moving body 22 has arrived at the target position C, the output control unit 35B displays a display frame F2 in a display form different from before determining the arrival at the target position C. The display frame F2 is a frame-like image in a display form different from the display frame F1. In addition, the output control unit 35B may display information in different display forms before and after determining that the moving body 22 has arrived at the target position C and the arrival information is received, and the method for changing the display forms is not limited to the presence or absence of the display frame F2.

FIG. 5E is an enlarged schematic diagram of a portion of the display screen 50A illustrated in FIG. 5A.

On the display screen 50A, a vehicle width guide G and the traveling path R are superimposed on the captured video V. In addition, a detection frame F4 indicating object detection is superimposed on the object detected by the sensor 22A appearing in the captured video V. In addition, an image indicating the target area Q may be displayed on the captured video V.

The vehicle width guide G is an image for guiding the position of the moving body 22 in a vehicle width direction when the moving body 22 travels along the traveling path R.

The output control unit 35B may superimpose, on the captured video V included in the display screen information received from the information processing device 10, the traveling path R indicated by the traveling path information included in the display screen information, the vehicle width guide G, the target area Q indicated by the target area information included in the display screen information, and the detection frame F4 indicating sensed objects around the moving body 22 indicated by the analysis results.

FIG. 5F is a schematic diagram of an example of the display screen 50B. The display screen 50B is an example of the display screen 50.

The display screen 50B may include a determination disabling button image B1, a forced arrival determination button image B2, and an arrival re-determination button image B3.

The determination disabling button image B1 is an instruction area for temporarily disabling the arrival determination for the moving body 22 by the determination unit 15B of the information processing device 10. When the operator X1 operates the display area of the determination disabling button image B1, the control unit 35 of the operator terminal 30 receives a temporary disabling instruction for arrival determination. When the control unit 35 receives the temporary disabling instruction for the arrival determination, the control unit 35 transmits the temporary disabling instruction information for the arrival determination to the information processing device 10. In detail, the control unit 35 transmits the temporary disabling instruction information for the arrival determination, including the moving body ID of the moving body 22 corresponding to the display area of the determination disabling button image B1, to the information processing device 10.

When the determination unit 15B of the information processing device 10 receives the temporary disabling instruction information for the arrival determination from the operator terminal 30, the determination unit 15B may temporarily disable the arrival determination for the moving body 22 identified by the moving body ID included in the temporary disabling instruction information for the arrival determination. By the temporary disabling, it means that the moving body 22 does not execute the arrival determination at the target position C of the moving body 22 for a predetermined time.

There may be cases when the operator X1 may want to manually adjust the timing of the arrival determination. For example, a situation may arise where an obstacle present in the target area Q may move, and it is expected that after a predetermined time elapses, the moving body 22 will be able to arrive at the target position C, and the like. In such a case, the operator X1 may operate the display area of the determination disabling button image B1 included in the display screen 50, so that the determination unit 15B of the information processing device 10 can temporarily disable the arrival determination for the moving body 22.

The forced arrival determination button image B2 is an instruction area for forcing the determination unit 15B of the information processing device 10 to determine that the moving body 22 has arrived at the target position C. When the operator X1 operates the display area of the forced arrival determination button image B2, the control unit 35 of the operator terminal 30 receives the forced arrival determination instruction. When the control unit 35 receives the forced arrival determination instruction, the control unit 35 transmits forced arrival determination instruction information to the information processing device 10. In detail, the control unit 35 transmits the forced arrival determination instruction information, including the moving body ID of the moving body 22 corresponding to the display area of the forced arrival determination button image B2, to the information processing device 10.

When the determination unit 15B of the information processing device 10 receives the forced arrival determination instruction information from the operator terminal 30, the determination unit 15B determines that the moving body 22 identified by the moving body ID included in the forced arrival determination instruction information has arrived at the target position C even when the arrival determination conditions are not satisfied for the moving body 22.

In this case, the output control unit 15C of the information processing device 10 preferably outputs the arrival information indicating that the moving body 22 has arrived at the target position C, and the position P of the moving body 22 at the time of determining the arrival, to at least one of the operator terminal 30 and the worker terminal 40. This is to notify the operator X1 and the worker X2 of the position P of the moving body 22.

The arrival re-determination button image B3 is an instruction area for causing the determination unit 15B of the information processing device 10 to re-determine whether the moving body 22 has arrived at the target position C. When the operator X1 operates the display area of the arrival re-determination button image B3, the control unit 35 of the operator terminal 30 receives the arrival re-determination instruction. When the control unit 35 receives the arrival re-determination instruction, the control unit 35 transmits arrival re-determination instruction information to the information processing device 10. In detail, the control unit 35 transmits the arrival re-determination instruction information, including the moving body ID of the moving body 22 corresponding to the display area of the arrival re-determination button image B3, to the information processing device 10.

When the determination unit 15B of the information processing device 10 receives the arrival re-determination instruction information from the operator terminal 30, the determination unit 15B may update the task execution state of the moving body 22, which is identified by the moving body ID included in the arrival re-determination instruction information, to the task execution state that is one step before in the execution order, and re-determine whether the arrival determination condition is satisfied.

In addition, the output control unit 15C may display the arrival re-determination button image B3 on the display screen 50 only when the task execution state of the moving body 22 is a predetermined execution state. For example, when the task execution state of the moving body 22 is any of states of "arrival at loading position", "loading", "arrival at delivery destination" or "unloading", the output control unit 15C preferably displays the arrival re-determination button image B3 on the display screen 50 to allow the operation by the operator X1.

Next, an example of a flow of information processing executed in the information processing system 1 according to the present embodiment will be described.

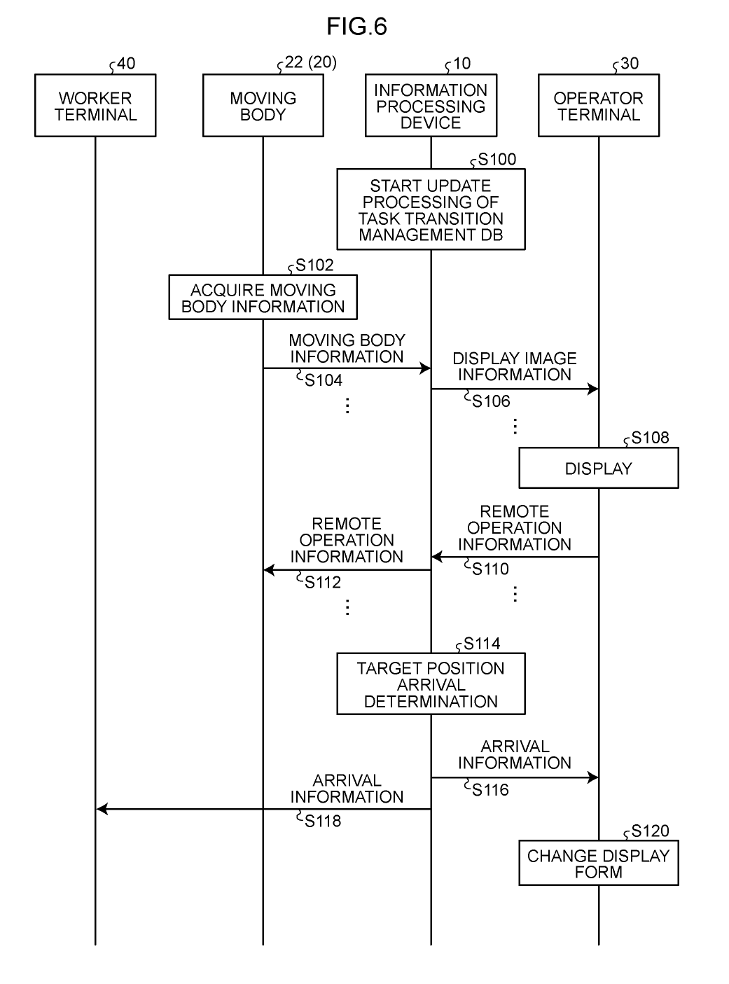

FIG. 6 is a sequence diagram illustrating an example of the flow of the information processing executed in the information processing system 1 according to the present embodiment.

The control unit 15 of the information processing device 10 starts update processing of the task execution states for each of the moving bodies 22 included in the information processing system 1 (step S100).

The control unit 15 updates the task execution state indicating a task being executed by the moving body 22 in the task transition management DB 14F, sequentially following the execution order registered in the task management master DB 14E from the top to the bottom according to the changes in the situation of the moving body 22. In addition, examples will be described based on the assumption that, from among a plurality of task execution states in the example illustrated in FIG. 3F, each of "arrival at loading position", "arrival at delivery destination" and "arrival at return position" refers to the arrival at the target position C.

In detail, the control unit 15 stores each moving body 22 in the task transition management DB 14F in association with the moving body ID of the moving body 22, the delivery ID for the moving body 22 identified by the moving body ID, and the traveling path ID indicating the traveling path of the moving body 22. In addition, in an initial state, the control unit 15 registers the target position ID corresponding to the latitude and longitude of the target position C upstream of the traveling direction included in the traveling path information indicated by the traveling path ID in the task transition management DB 14F, in association with the moving body ID. In addition, in the initial state, the control unit 15 registers "preparing" at execution order "1", which is the highest order that is registered in the task management master DB 14E, in the task transition management DB 14F as the task execution state of the moving body 22.

Then, when the moving body 22 starts moving to the position P, the control unit 15 updates the task execution state corresponding to the moving body ID of the moving body 22 in the task transition management DB 14F from "preparing" at execution order "1" to "moving to loading position" at execution order "2". Then, when the control unit 15 determines that the moving body 22 has arrived at the target position C, the control unit 15 updates the task execution state corresponding to the moving body ID of the moving body 22 in the task transition management DB 14F from "moving to loading position" at execution order "2" to "arrival at loading position" at execution order "3". In addition, the control unit 15 updates the target position ID corresponding to the moving body ID of the moving body 22 in the task transition management DB 14F to the target position ID corresponding to the latitude and longitude of the next target position C in the traveling direction included in the traveling path information indicated by the traveling path ID.

Then, furthermore, when a predetermined time elapses, the control unit 15 updates the task execution state corresponding to the moving body ID of the moving body 22 in the task transition management DB 14F from "arrival at loading position" at execution order "3" to "loading" at execution order "4". When the control unit 15 receives a loading operation signal from the worker terminal 40 indicating the completion of loading operation onto the moving body 22, the control unit 15 updates the task execution state corresponding to the moving body ID of the moving body 22 in the task transition management DB 14F from "loading" at execution order "4" to "waiting to start delivery" at execution order "5".

When the control unit 15 detects a movement of the position P of the moving body 22, the control unit 15 updates the task execution state corresponding to the moving body ID of the moving body 22 in the task transition management DB 14F from "waiting to start delivery" at execution order "5" to "delivering" at execution order "6".

Then, when the control unit 15 determines that the moving body 22 has arrived at the target position C, the control unit 15 updates the task execution state corresponding to the moving body ID of the moving body 22 in the task transition management DB 14F from "delivering" at execution order "6" to "arrival at delivery destination" at execution order "7". In addition, the control unit 15 updates the target position ID corresponding to the moving body ID of the moving body 22 in the task transition management DB 14F to the target position ID corresponding to the latitude and longitude of the next target position in the traveling direction included in the traveling path information indicated by the traveling path ID.

Then, furthermore, when a predetermined time elapses, the control unit 15 updates the task execution state corresponding to the moving body ID of the moving body 22 in the task transition management DB 14F from "arrival at delivery destination" at execution order "7" to "unloading" at execution order "8". When the control unit 15 receives an unloading operation signal from the worker terminal 40 indicating the completion of unloading operation from the moving body 22, the control unit 15 updates the task execution state corresponding to the moving body ID of the moving body 22 in the task transition management DB 14F from "unloading" at execution order "8" to "waiting to start return" at execution order "9".

When the control unit 15 detects a movement of the position P of the moving body 22, the control unit 15 updates the task execution state corresponding to the moving body ID of the moving body 22 in the task transition management DB 14F from "waiting to start return" at execution order "9" to "returning" at execution order "10".

Then, when the control unit 15 determines that the moving body 22 has arrived at the target position C, the control unit 15 updates the task execution state corresponding to the moving body ID of the moving body 22 in the task transition management DB 14F from "returning" at execution order "10" to "arrival at return position" at execution order "11". Then, when a predetermined time elapses, the control unit 15 updates the task execution state corresponding to the moving body ID of the moving body 22 in the task transition management DB 14F from "arrival at return position" at execution order "11" to "delivery completed" at execution order "12".

In step S100, the control unit 15 starts the update processing of these task execution states. The update processing of these task execution states by the control unit 15 is continuously executed during the processing subsequent to step S100.

The moving body information transmission unit 28C of the moving body system 20 starts transmitting the moving body information 27A of the moving body 22 to the information processing device 10 (steps S102 and S104).

Each time the output control unit 15C of the information processing device 10 receives the moving body information 27A, the output control unit 15C starts transmitting display image information including the received moving body information 27A to the operator terminal 30 (step S106). The output control unit 35B of the operator terminal 30 outputs the display screen 50 indicated by the received display image information to the output unit 33 (step S108).

The remote operation control unit 35C transmits, to the information processing device 10, remote operation information corresponding to the operation instruction to the moving body 22 input according to an operation of the input unit 32 by the operator X1, together with the moving body ID of the moving body 22 (step S110). The information processing device 10 transmits the remote operation information to the moving body 22 identified by the moving body ID (step S112). The moving body 22 controls the driving unit 22B based on the remote operation information to move the moving body 22 according to the remote operation by the operator X1. Therefore, the moving body 22 is remotely operated by the operator X1 operating the operator terminal 30.

During the processing, the determination unit 15B of the information processing device 10 determines whether an arrival determination condition that the position P of the moving body 22 is within the target area Q is satisfied (step S114). In addition, as described above, The arrival determination condition may indicate that the position of the moving body 22 is within the target area Q that includes the target position C of the moving body 22 and that the current moving body state of the moving body 22 is "stop". In addition, the arrival determination condition may indicate that the position of the moving body 22 is within the target area Q that includes the target position C of the moving body 22, and that the current moving body state of the moving body 22 is "normal stop". Here, the description will be given based on the assumption that the determination unit 15B determines that the arrival determination condition is satisfied.

The output control unit 15C of the information processing device 10 outputs the arrival information to the operator terminal 30 and the worker terminal 40 (steps S116 and S118). The operator terminal 30 receiving the arrival information displays the display form of the display screen 50 in a display form different from that before receiving the arrival information (step S120). Then, the sequence ends.

Next, an example of a flow of information processing executed by the information processing device 10 will be described.

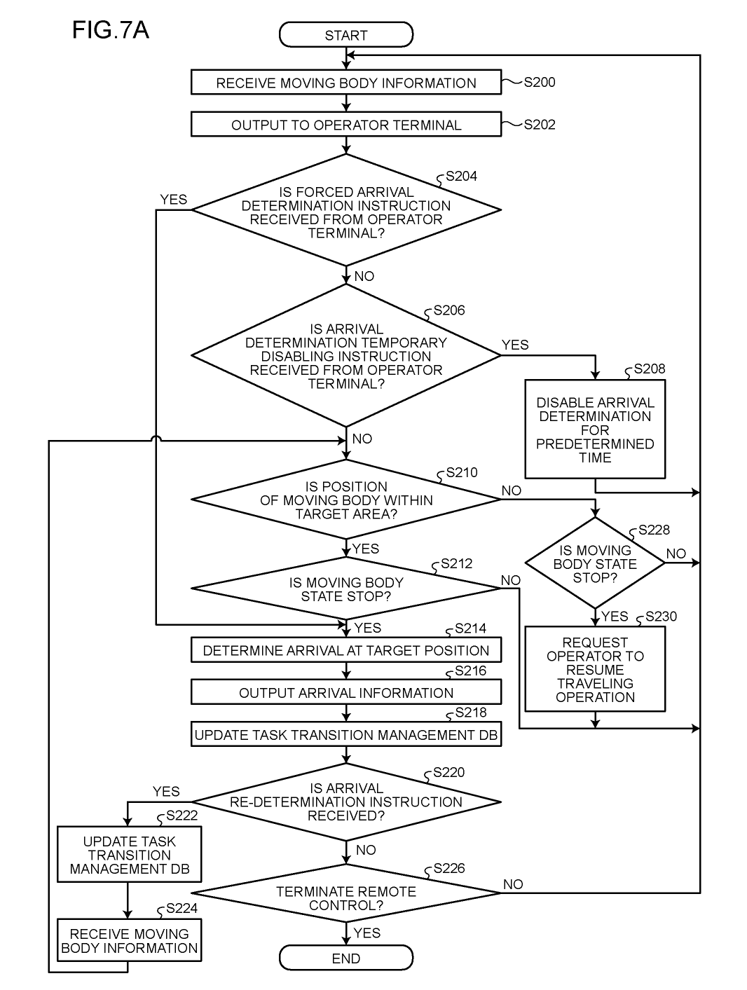

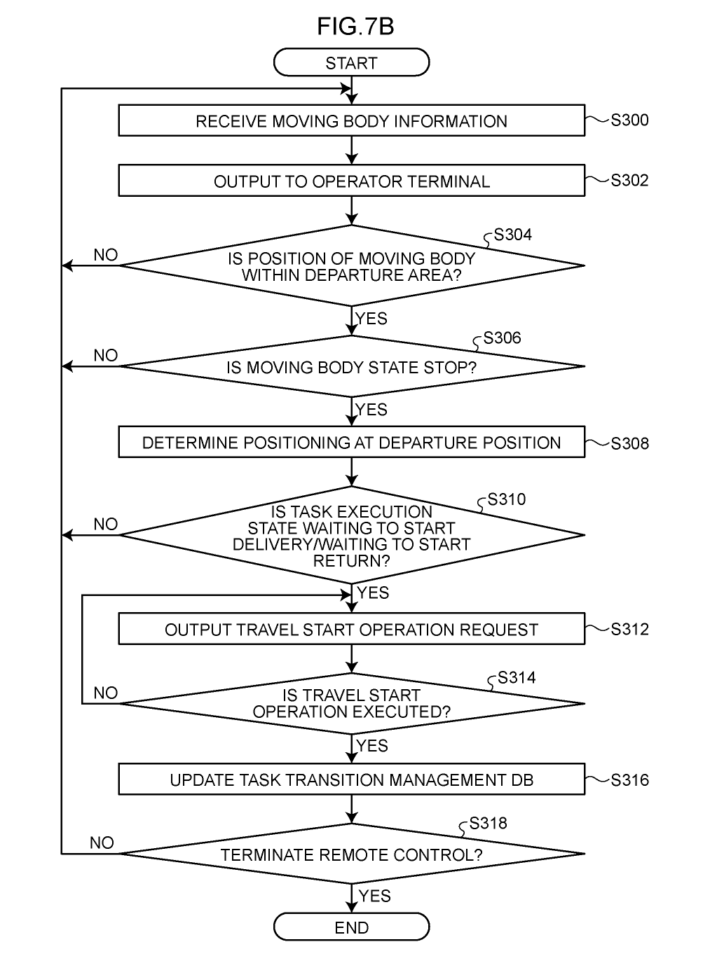

FIG. 7A is a flowchart illustrating an example of the flow of the information processing executed by the information processing device 10.

The information processing device 10 executes the processing of steps S200 to S226 for each delivery task of the moving body 22 managed by the information processing system 1. In addition, the information processing device 10 executes the update processing of the task execution state described above for each moving body 22 during the processing of the steps S200 to S226.

The information reception unit 15A receives the moving body information 27A from the moving body system 20 (step S200).

The output control unit 15C outputs the display image information including the moving body information 27A received in step S200 to the operator terminal 30 (step S202). The output control unit 35B of the operator terminal 30 outputs the display screen 50 indicated by the received display image information to the output unit 33.

The information reception unit 15A determines whether the forced arrival determination instruction is received from the operator terminal 30 (step S204). The information reception unit 15A executes the determination of step S204 by determining whether the forced arrival determination instruction information is received from the operator terminal 30. For a positive determination in step S204 (step S204: Yes), the process proceeds to step S214. For a negative determination in step S204 (step S204: No), the process proceeds to step S206.

In step S206, the information reception unit 15A determines whether a temporary disabling instruction for arrival determination is received from the operator terminal 30 (step S206). The information reception unit 15A executes the determination of step S206 by determining whether the temporary disabling instruction information for the arrival determination is received from the operator terminal 30. For a positive determination in step S206 (step S206: Yes), the process proceeds to step S208.

In step S208, for the moving body 22 identified by the moving body ID included in the temporary disabling instruction information for the arrival determination received in step S206, the control unit 15 disables the arrival determination for the moving body 22 at the target position C for a predetermined time (step S208). Then, the process returns to step S200 described above.

For a negative determination in step S206 (step S206: No), the process proceeds to step S210.

In step S210, the determination unit 15B determines whether the position P of the moving body 22 is within the target area Q that includes the target position C of the moving body 22 (step S210). The determination unit 15B specifies the position of the moving body 22 indicated by the latest moving body information 27A received from the moving body 22 in step S200 or step S224 to be described below. In addition, the determination unit 15B reads, from the target position management DB 14C, the target area information corresponding to the target position ID associated with the moving body ID of the moving body 22 in the task transition management DB 14F. Then, the determination unit 15B determines whether the position P of the specified moving body 22 is within the target area Q indicated by the read target area information, and determines whether the position of the moving body 22 is within the target area Q that includes the target position C of the specified moving body 22.

For a negative determination in step S210 (step S210: No), the process proceeds to step S228. In step S228, the determination unit 15B determines whether the current moving body state of the moving body 22 is "stop" (step S228). The determination unit 15B may determine whether the current moving body state of the moving body 22 is "normal stop". For a negative determination in step S228 (step S228: No), the process returns to step S200 described above. For a positive determination in step S228 (step S228: Yes), the process proceeds to step S230. In step S230, the output control unit 15C outputs travel restart operation request information indicating a travel restart operation request for the moving body 22 to the operator terminal 30 (step S230). The operator terminal 30 receiving the travel restart operation request information displays alert information indicating the travel restart operation request to the moving body 22. Therefore, the alert information indicating the travel restart operation request for the moving body 22 is displayed on the operator terminal 30. Then, the output control unit 15C repeats the negative determination until it is determined that the travel restart operation is performed by the operator X1, and returns to step S200 when it is determined that the travel restart operation is performed.

For a positive determination in step S210 (step S210: Yes), the process proceeds to step S212.

In step S212, the determination unit 15B determines whether the current moving body state of the moving body 22 is "stop" (step S212). The determination unit 15B may determine whether the current moving body state of the moving body 22 is "normal stop". For a negative determination in step S212 (step S212: No), the process returns to step S200 above. For a positive determination in step S212 (step S212: Yes), the process proceeds to step S214.

In step S214, the determination unit 15B determines that the moving body 22 is positioned at the target position C. That is, in the present embodiment, the determination unit 15B determines that the moving body 22 has arrived at the target position C (step S214). Then, the output control unit 15C outputs the arrival information indicating that the moving body 22 has arrived at the target position C to the operator terminal 30 and the worker terminal 40 (step S216).

Next, the output control unit 15C updates the task execution state in the task transition management DB 14F, which corresponds to the moving body ID of the moving body 22 determined to have arrived at the target position C, to the task execution state that is next in the execution order after the current task execution state in the task management master DB 14E (step S218). By the processing of step S218, the task execution state of the moving body 22 is updated to "arrival at loading position", "arrival at delivery destination", or "arrival at return position", indicating the arrival at the target position C according to the current task execution state before updating.

Next, the determination unit 15B determines whether the arrival re-determination instruction is received from the operator terminal 30 (step S220). The determination unit 15B determines whether the arrival re-determination instruction information is received from the operator terminal 30, thereby executing the determination of step S220. For a positive determination in step S220 (step S220: Yes), the process proceeds to step S222.

In step S222, the control unit 15 updates the task execution state corresponding to the moving body ID of the moving body 22 to be processed in the task transition management DB 14F to the task execution state that is one step before the current task execution state in the task management master DB 14E (step S222). By the processing of step S222, the task execution state of the moving body 22 is updated from "arrival at loading position", "arrival at delivery destination", or "arrival at return position", which indicate the arrival at the target position C, to the task execution state corresponding to that one step before in the execution order. Then, when the information reception unit 15A acquires the moving body information 27A from the moving body 22 (step S224), the process returns to step S210.

Meanwhile, for a negative determination in step S220 (step S220: No), the process proceeds to step S226. In step S226, the control unit 15 determines whether to terminate remote control for the moving body 22 (step S226). For example, the control unit 15 executes the processing of step S226 by determining whether remote control termination instruction information indicating a remote control termination instruction, which includes the moving body ID of the moving body 22, is received from the operator terminal 30. For a negative determination in step S226 (step S226: No), the process returns to step S200 described above. For a positive determination in step S226 (step S226: Yes), this routine ends.

As described above, the information processing device 10 according to the present embodiment receives the moving body information 27A including the position P of the moving body 22 by the information reception unit 15A. The determination unit 15B determines that the moving body 22 is positioned at the target position C (specific position) when the position P of the moving body 22 satisfies the arrival determination condition (specific determination condition) within the target area Q (specific area) that includes the target position C (specific position) of the moving body 22.

In this way, the information processing device 10 according to the present embodiment determines that the moving body 22 is positioned at the target position C (specific position) when determining that the position P of the moving body 22 is within the target area Q (specific area), which is an area of a predetermined range that includes the target position C (specific position), rather than when determining that the position P of the moving body 22 coincides with the target position C (specific position).

Therefore, in the information processing device 10 according to the present embodiment, even when it is difficult for the moving body 22 to arrive at a position that coincides with the target position C due to the presence of obstacles around the target position C, etc., it can be determined that the moving body 22 is positioned at the target position C because the moving body 22 is positioned within the target area Q. Consequently, when the moving body 22 is in a situation where it is difficult to arrive at a position that coincides with the target position C, inability to execute scheduled work or the like by remote control at the target position C can be prevented, and suitable remote control support can be executed.

Accordingly, the information processing device 10 according to the present embodiment can perform suitable remote control support.

In addition, in the information processing device 10 according to the present embodiment, when the moving body 22 is in a situation where it is difficult to arrive at a position that coincides with the target position C, situations such as being unable to carry out work scheduled to be performed at the target position C, etc. are prevented, thereby improving the flexibility of operation of various services provided by the moving body 22.

In addition, in the information processing device 10 according to the present embodiment, the information reception unit 15A receives the moving body information 27A including the position P of the moving body 22 and the moving body state of the moving body. The determination unit 15B determines that the moving body 22 has arrived at the target position C when the arrival determination condition that the position P of the moving body 22 is within the target area Q and the moving body state indicates stop is satisfied.

Therefore, in the information processing device 10 according to the present embodiment, when the moving body 22 is stopped within the target area Q, it can be determined that the moving body 22 has arrived at the target position C, making it possible to determine arrival at the target position C with high accuracy while preventing interference with remote control.

In addition, in the information processing device 10 according to the present embodiment, the determination unit 15B determines that the moving body 22 has not arrived at the target position C when the arrival determination condition is satisfied, but a temporary disabling instruction for arrival determination is received from the operator terminal 30 via the display screen 50.

For example, an obstacle present in the target area Q may move after a predetermined time, and the operator X1 who is remote controlling may predict that the moving body 22 can be disposed at a position that coincides with the target position C or closer to the target position C after the predetermined time elapses. In such a case, the information processing device 10 receives a temporary disabling instruction for arrival determination by the operation on the determination disabling button image B1 included in the display screen 50 by the operator X1 such that the determination unit 15B can determine that the moving body 22 has not arrived at the target position C. Therefore, the information processing device 10 according to the present embodiment can enable manual adjustment of the arrival determination by the operator X1, allowing to perform more suitable remote control support.

In the information processing device 10 according to the present embodiment, when the determination unit 15B receives the forced arrival determination instruction from the operator terminal 30 via the display screen 50, the determination unit 15B determines that the moving body 22 has arrived at the target position C.

For example, there may be situations where, due to the influence of obstacles present in the target area Q and the like, the moving body 22 may be in a situation where it is difficult to enter the target area Q. In such a case, when the information processing device 10 receives the forced arrival determination instruction by the operation on the forced arrival determination button image B2 included in the display screen 50 by the operator X1, the determination unit 15B can determine that the moving body 22 has reached the target position C. Therefore, the information processing device 10 according to the present embodiment can enable manual adjustment of the arrival determination by the operator X1, allowing to perform more suitable remote control support.

In addition, when the arrival determination condition that the position P of the moving body 22 is within the target area is satisfied and when the arrival re-determination instruction is received from the operator terminal 30 via the display screen 50, the determination unit 15B of the information processing device 10 according to the present embodiment re-determines whether the moving body 22 has arrived at the target position C.

For example, although the position P of the moving body 22 does not coincide with the target position C, there are cases where the position P of the moving body 22 coincides with the target position C or the moving body 22 can be moved to a position closer to the target position C after it is determined that the moving body 22 has arrived at the target position C because the position P of the moving body 22 is within the target area Q. In such a case, the information processing device 10 receives the arrival re-determination instruction by the operation on the arrival re-determination button image B3 included in the display screen 50 by the operator X1, so that the determination unit 15B can re-determine whether the moving body 22 has reached the target position C. Therefore, the information processing device 10 according to the present embodiment can enable manual adjustment of the arrival determination by the operator X1, allowing to perform more suitable remote control support.

In addition, the output control unit 15C of the information processing device 10 according to the present embodiment outputs the display screen 50 displaying the positional relationship between the target area Q and the moving body 22 to the operator terminal 30 of the operator X1 who is remotely controlling the moving body 22.

Therefore, the information processing device 10 according to the present embodiment can provide the positional relationship between the target area Q and the moving body 22 in a form recognizable to the worker X2, and can provide suitable remote control support.

In addition, the output control unit 15C of the information processing device 10 according to the present embodiment outputs the display screen 50 in the first display form to the operator terminal 30 when the position P of the moving body 22 is within the target area Q, and outputs the display screen 50 in the second display form to the operator terminal 30 when the position P of the moving body 22 is outside the target area Q.

Therefore, the information processing device 10 according to the present embodiment can change the display form of the display screen 50 to easily provide the operator X1 with information on whether the position P of the moving body 22 is within the target area Q or outside the target area Q in an easily recognizable manner.

In addition, the output control unit 15C of the information processing device 10 according to the present embodiment outputs, to the operator terminal 30, the display screen 50 on which an image indicating the position P of the moving body 22 and an image indicating the target area Q are superimposed on at least one of the map image M indicating the traveling environment of the moving body 22 and the captured video V of the surroundings of the moving body 22.

Therefore, the information processing device 10 according to the present embodiment can perform more suitable remote control support.

In addition, the output control unit 15C of the information processing device 10 according to the present embodiment outputs, to the operator terminal 30, the display screen 50 on which an image indicating the traveling path R of the moving body 22 is superimposed on at least one of the map image M indicating the traveling environment of the moving body 22 and the captured video V of the surroundings of the moving body 22.

Therefore, the information processing device 10 according to the present embodiment can perform more suitable remote control support.

In addition, the output control unit 15C of the information processing device 10 according to the present embodiment outputs, to the operator terminal 30, the display screen 50 including the remaining distance information indicating the remaining distance from the position P of the moving body 22 to the target position C.

Therefore, the information processing device 10 according to the present embodiment can perform more suitable remote control support.

In addition, when it is determined that the moving body 22 has arrived at the target position C, the output control unit 15C of the information processing device 10 according to the present embodiment outputs the arrival information indicating that the moving body 22 has arrived at the target position C to at least one of the operator terminal 30 and the worker terminal 40 of the worker X2 who performs work using the moving body 22 in the real space RS.

Therefore, the information processing device 10 according to the present embodiment can notify the operator X1 of the operator terminal 30 and the worker X2 of the worker terminal 40 that the moving body 22 has arrived at the target position C.

### First Modification

In the embodiment described above, the arrangement has been described by way of example, in which the specific position is the target position and the specific area is the target area. However, the specific position may be a departure position of the moving body 22, and the specific area may be a departure area that includes the departure position.

The definition of the departure position and the departure area is the same as that of the embodiment described above except that the position is the departure position in place of the target position of the moving body 22, and the area is the departure area that includes the departure position instead of the target position.

That is, the departure position is one point indicated by the latitude and longitude in the real space. The departure position is the position information of the departure point of the moving body 22. The departure area is an area that includes the departure position of the moving body 22. The departure area is a wider range of area than the departure position. In the departure area, a point occupying a portion of the departure area is the departure position.

The departure area is, like the target area, for example, a circular area having a predetermined radius centered at the departure position, or an area surrounding a target object disposed at the departure position, and the like.

In this case, a departure position ID, the departure position (latitude and longitude), and departure area information (e.g., information indicating the radius from the departure position) may be registered in advance in association with each other in the target position management DB 14C (see FIG. 3D). The departure position ID is identification information of the departure position. In addition, in addition to the target position ID, the target position, and the target area information, the departure position ID, the departure position, and the departure area information may be registered in association with the target position management DB 14C in advance.

In addition, the departure position ID may be registered in the task transition management DB 14F in place of the target position ID or together with the target position ID (see FIG. 3G).

The determination unit 15B determines that the moving body 22 is positioned at the specific position when the specific determination condition is satisfied, as in the embodiment described above. As described in the embodiment described above, the specific determination condition indicates that the position of the moving body 22 is within the specific area that includes the specific position of the moving body 22.

In the present modification, an arrangement will be described by way of example, in which the specific position is the departure position and the specific area is the departure area. Therefore, in the present modification, the specific determination condition indicates that the position of the moving body 22 is within the departure area that includes the departure position of the moving body 22.

In the present modification, when the specific determination condition is satisfied, the determination unit 15B determines that the moving body 22 is positioned at the departure position and outputs travel start request information to the operator terminal 30 of the operator X1 who is remotely controlling the moving body 22.

The specific determination condition in the present modification may indicate, like the arrival determination condition described in the embodiment described above, that the position of the moving body 22 is within the departure area that includes the departure position of the moving body 22 and that the current moving body state of the moving body 22 is "stop". In addition, the specific determination condition may indicate that the position of the moving body 22 is within the departure area that includes the departure position of the moving body 22 and that the current moving body state of the moving body 22 is "normal stop". The determination unit 15B determines whether the moving body state included in the latest moving body information 27A received from the moving body 22 is "stop" or "normal stop" to determine whether the moving body state of the moving body 22 is "stop" or "normal stop".

Then, when it is determined that the moving body 22 is positioned at the departure position, the output control unit 15C may output the travel start request information indicating a travel start request of the moving body 22 to the operator terminal 30. Therefore, alert information indicating the travel start request to the moving body 22 is displayed on the display screen 50 displayed on the operator terminal 30.

In addition, when it is determined that the moving body 22 is positioned at the departure position and that the task execution state of the moving body 22 is "waiting to start delivery" or "waiting to start return", the output control unit 15C may output the travel start request information indicating the travel start request of the moving body 22 to the operator terminal 30.

In addition, the determination unit 15B may determine that the moving body 22 is positioned at the departure position when the position of the moving body 22 is within the specific area that includes the specific position of the moving body 22, when the moving body state is "stop" or "normal stop", and when the task execution state of the moving body 22 is "waiting to start delivery" or "waiting to start return".

Next, an example of a flow of information processing executed by the information processing device 10 of the present modification will be described.

FIG. 7B is a flowchart illustrating an example of the flow of the information processing executed by the information processing device 10.

The information processing device 10 executes the processing of steps S300 to S316 for each delivery task of the moving body 22 managed by the information processing system 1. In addition, the information processing device 10 executes the update processing of the task execution state described above for each moving body 22 during the processing of the steps S300 to S316.

The information reception unit 15A receives the moving body information 27A from the moving body system 20 (step S300).

The output control unit 15C outputs the display image information including the moving body information 27A received in step S300 to the operator terminal 30 (step S302). The output control unit 35B of the operator terminal 30 outputs the display screen 50 indicated by the received display image information to the output unit 33.

Next, the determination unit 15B determines whether the position P of the moving body 22 is within the departure area that includes the departure position of the moving body 22 (step S304). The determination unit 15B specifies the position of the moving body 22 indicated by the latest moving body information 27A received from the moving body 22 in step S300. In addition, the determination unit 15B reads the departure area information corresponding to the departure position ID associated with the moving body ID of the moving body 22 in the task transition management DB 14F from the target position management DB 14C. Then, the determination unit 15B determines whether the position of the specified moving body 22 is within the departure area indicated by the read departure area information, and determines whether the position of the moving body 22 is within the departure area that includes the departure position of the moving body 22.

For a negative determination in step S304 (step S304: No), the process returns to step S300 above. For a positive determination in step S304 (step S304: Yes), the process proceeds to step S306.

In step S306, the determination unit 15B determines whether the current moving body state of the moving body 22 is "stop" (step S306). The determination unit 15B may determine whether the current moving body state of the moving body 22 is "normal stop". For a negative determination in step S306 (step S306: No), the process returns to step S300 above. For a positive determination in step S306 (step S306: Yes), the process proceeds to step S308.

In step S308, the determination unit 15B determines that the moving body 22 is positioned at the departure position (step S308).

Next, the determination unit 15B determines whether the task execution state of the moving body 22 is "waiting to start delivery" or "waiting to start return" (step S310). As described above, the determination of step S310 may be executed at a timing between step S308 and step S306. For a negative determination in step S310 (step S310: No), the process returns to step S300 above. For a positive determination in step S310 (step S310: Yes), the process proceeds to step S312.

In step S312, the output control unit 15C outputs the travel start operation request information indicating the travel start operation request of the moving body 22 to the operator terminal 30 (step S312).

Next, the output control unit 15C determines whether the travel start operation is performed by the operator X1 (step S314). For a negative determination in step S314 (step S314: No), the process returns to step S312. For a positive determination in step S314 (step S314: Yes), the process proceeds to step S316.

Next, the output control unit 15C updates the task execution state in the task transition management DB 14F corresponding to the moving body ID of the moving body 22, which is determined to have arrived at the departure position, to the task execution state that is next in the execution order after the current task execution state in the task management master DB 14E (step S316).

Next, the control unit 15 determines whether to terminate remote control for the moving body 22 (step S318). The determination of step S318 may be executed in the same way as step S226 described above. For a negative determination in step S318 (step S318: No), the process returns to step S300 described above. For a positive determination in step S318 (step S318: Yes), the routine ends.

As described above, in the information processing device 10 of the present modification, when the position of the moving body 22 is within the departure area that includes the departure position of the moving body 22, the control unit 15 determines that the moving body 22 is positioned at the departure position and outputs the travel start request information to the operator terminal 30 of the operator X1 who is remotely controlling the moving body 22.

Therefore, in the information processing device 10 of the present modification, even when the moving body 22 is present in a position deviating from the departure position, once the moving body 22 is positioned at the departure area that includes the departure position, it can be determined that the moving body 22 is positioned at the departure position, and the travel start request information of the moving body 22 can be output to the operator terminal 30. Therefore, in the information processing device 10 of the present modification, even when it is difficult for the moving body 22 to be at the position that coincides with the departure position for some reason, the travel start request information of the moving body 22 can be output to the operator terminal 30.

Accordingly, the information processing device 10 of the present modification can perform a suitable remote control support as in the embodiment described above.

### Second Modification

In the present modification, the display screen 50 output to the output unit 33 of the operator terminal 30 will be described in detail. In the present modification, the display screen 50 output to the output unit 33 of the operator terminal 30 will be referred to as a display screen 60 in the following description. The display screen 60 is an example of the display screen 50.

In addition, the present modification will be described based on an assumption that remote control of the moving body 22 by the operator X1 is executed in one user interface (UI).

As described in the embodiment described above, the output control unit 35B of the operator terminal 30 outputs, to the output unit 33, a display screen indicated by the display screen information received from the information processing device 10.

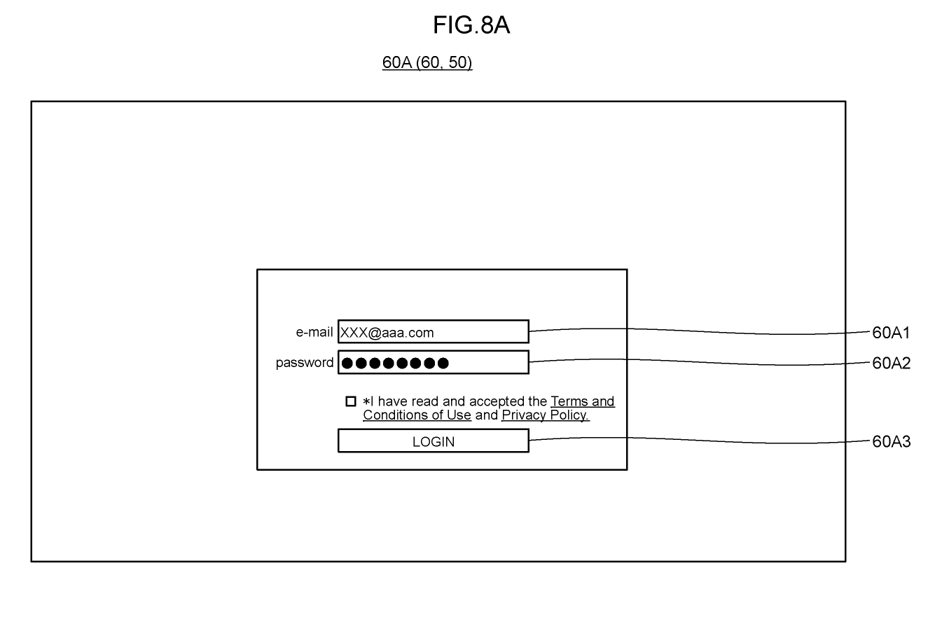

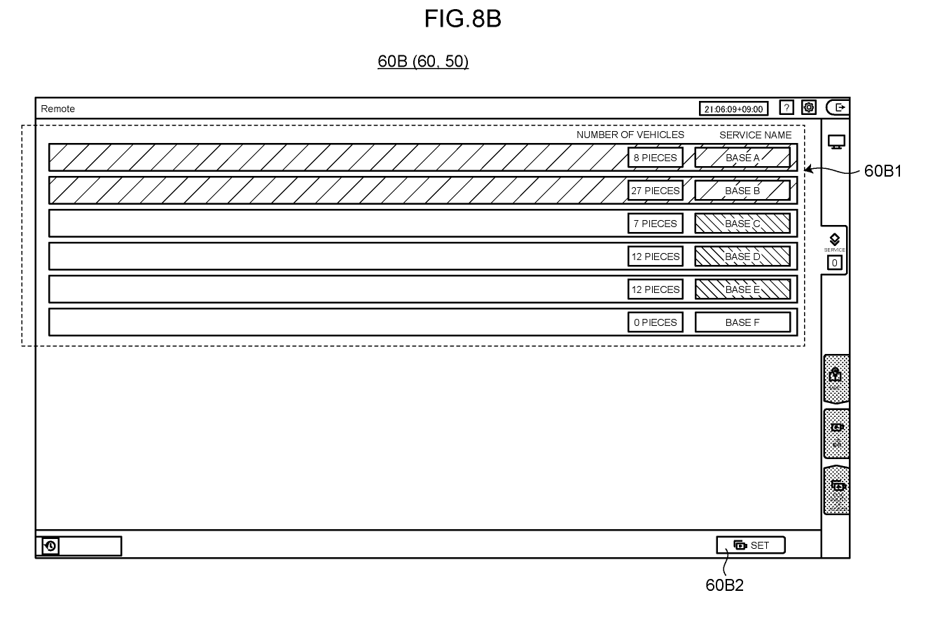

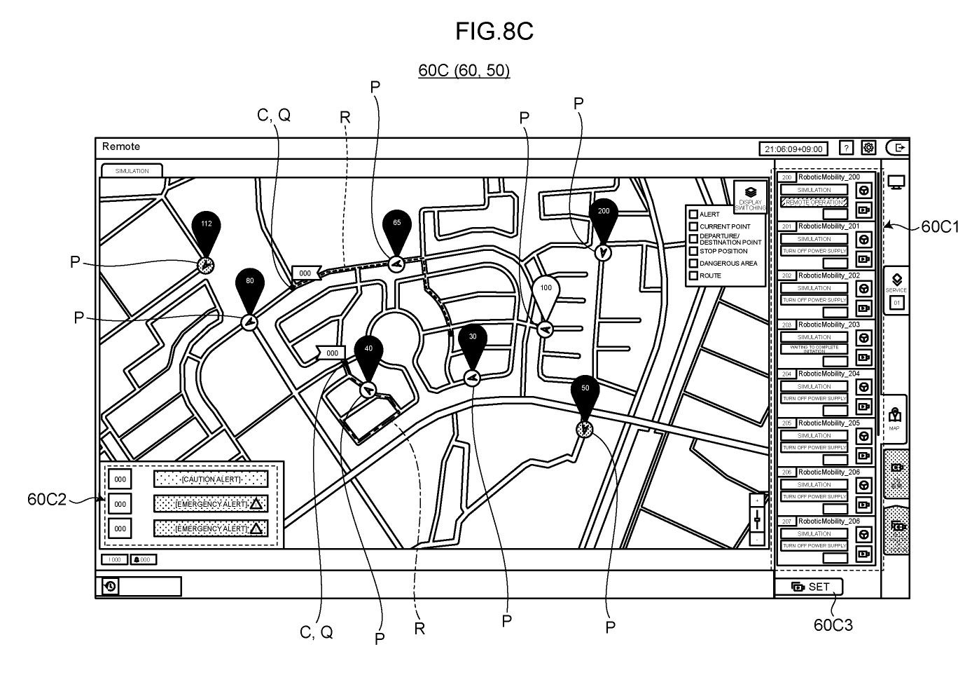

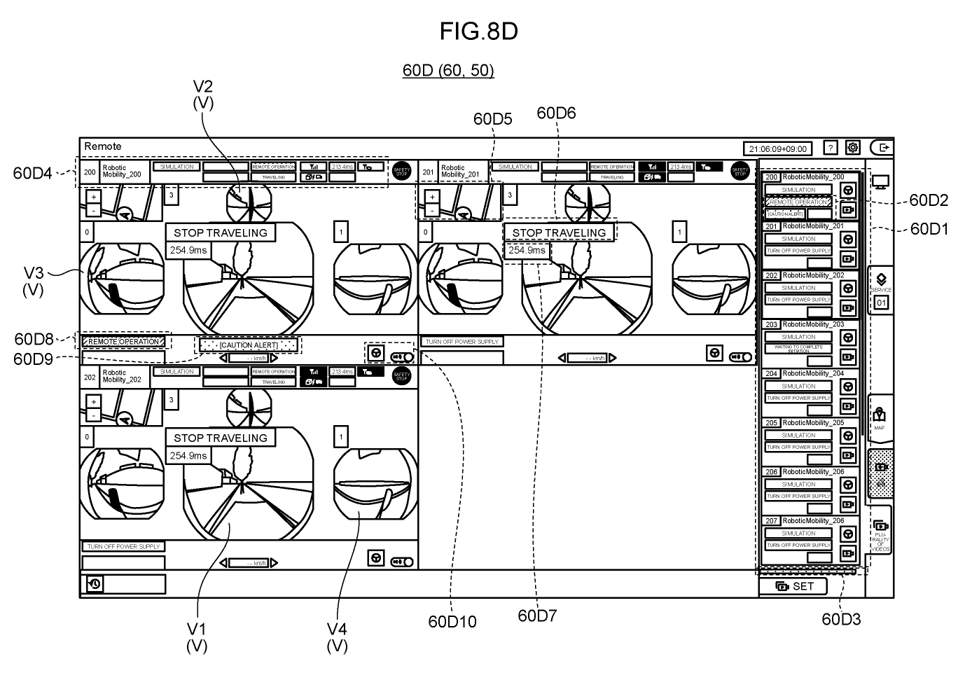

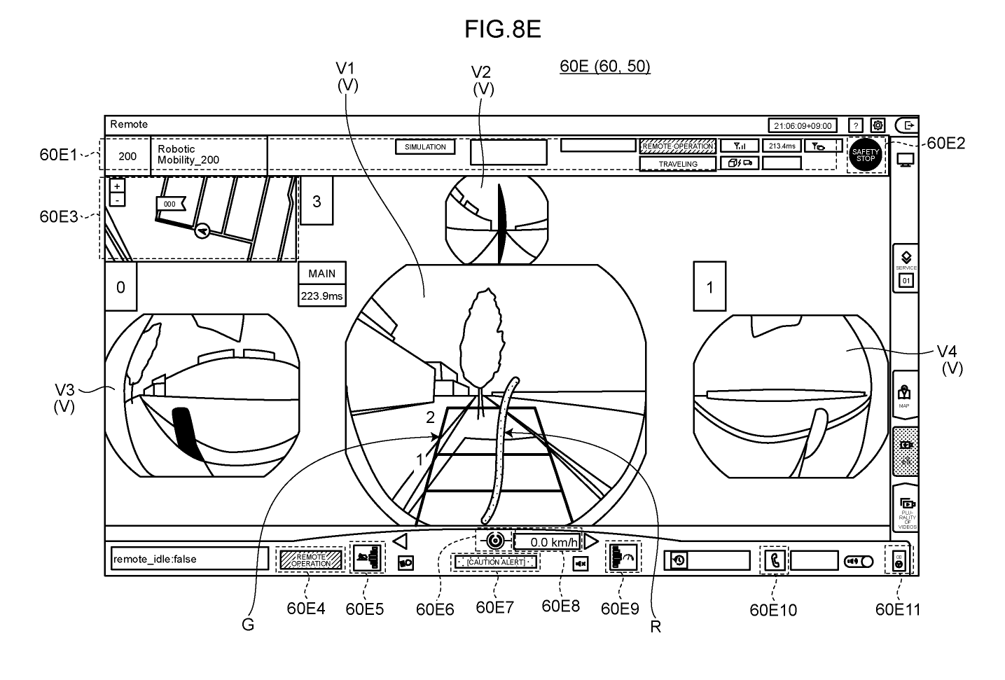

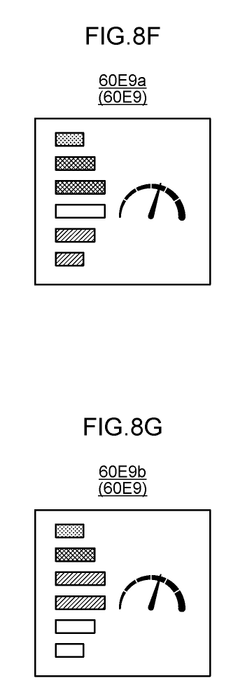

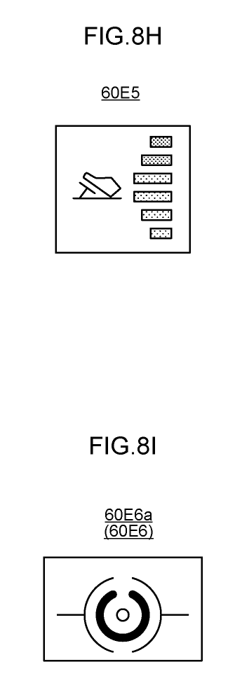

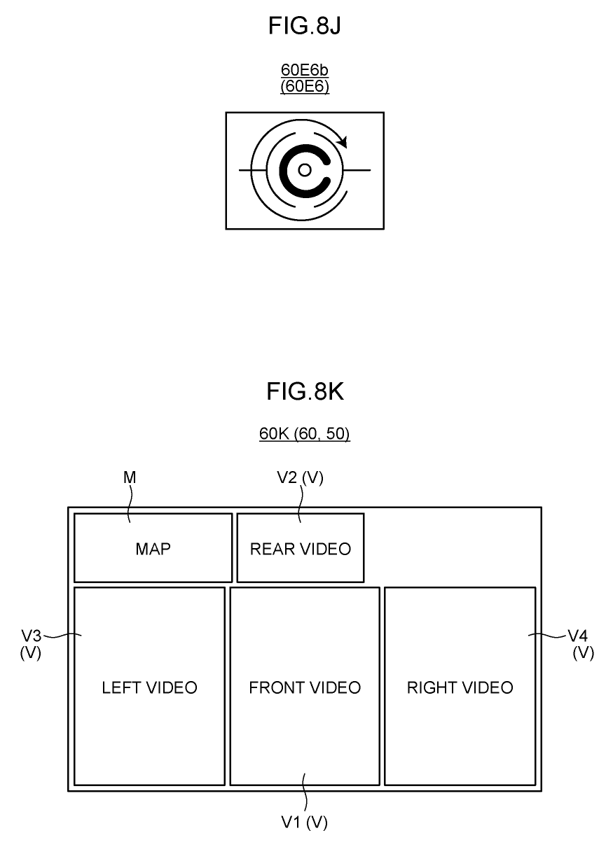

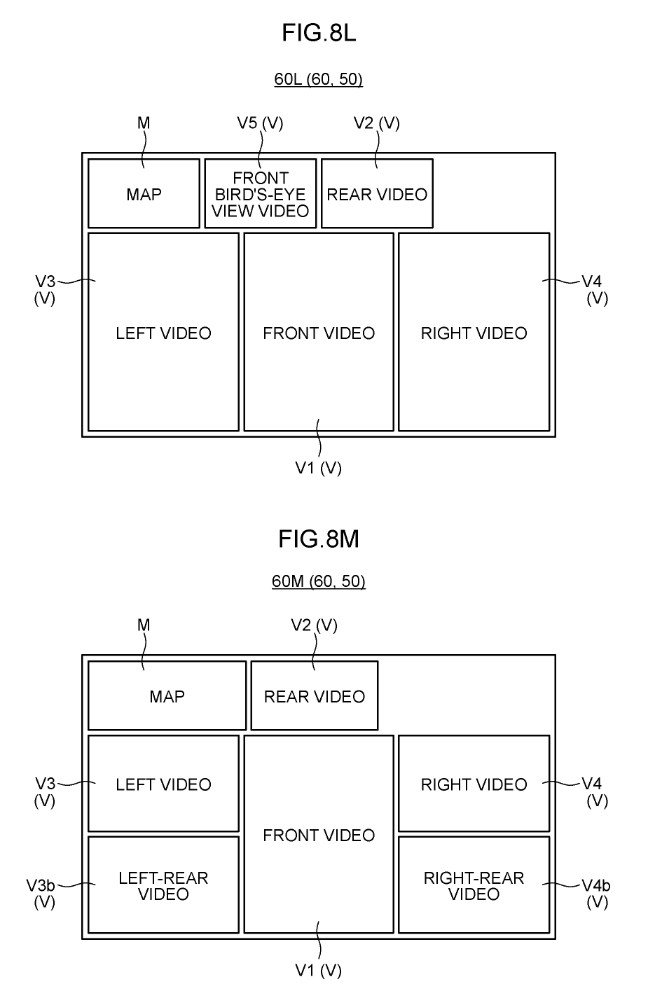

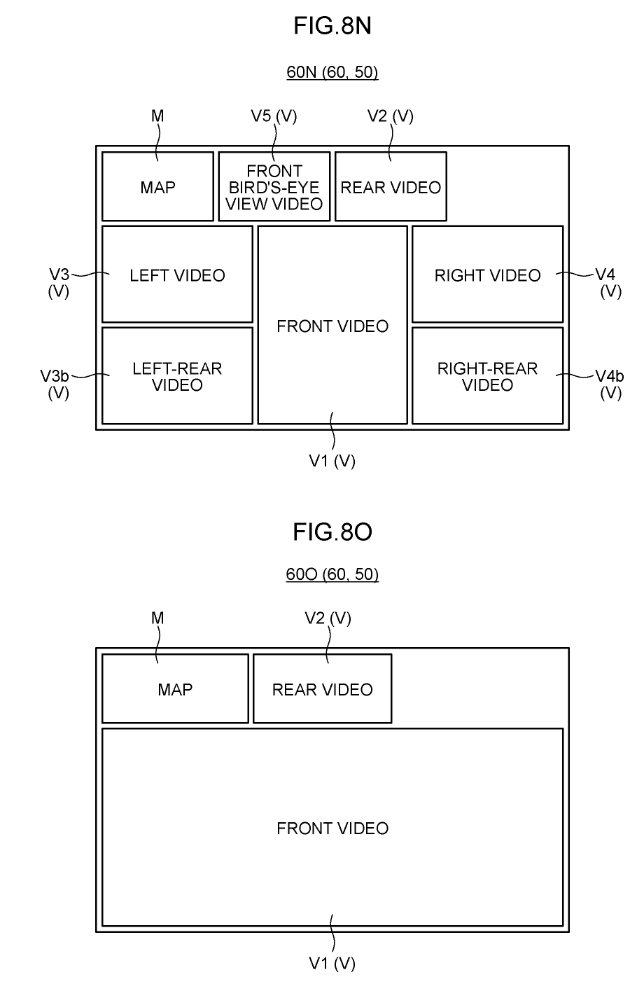

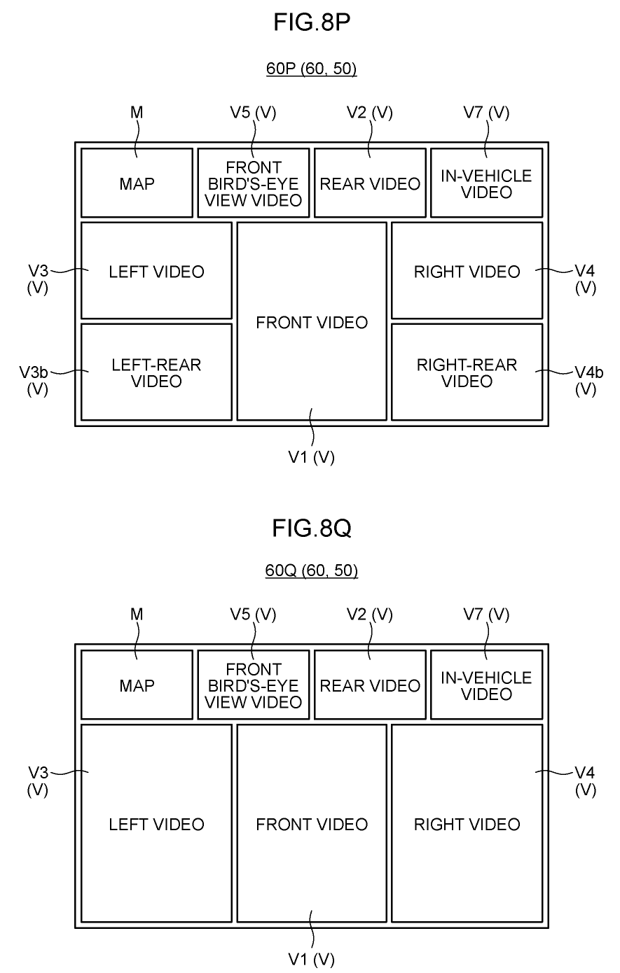

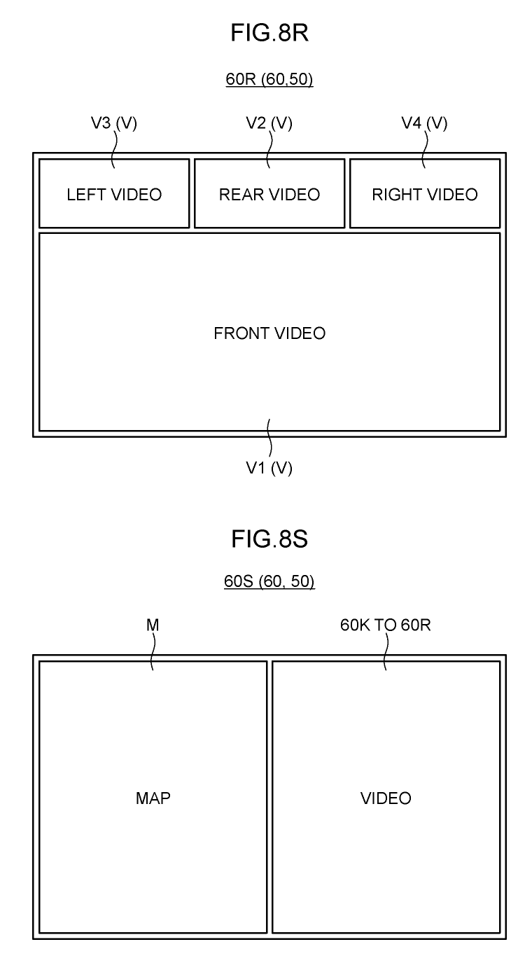

FIG. 8A is a schematic diagram of an example of a display screen 60A. The display screen 60A is an example of the display screen 60 and the display screen 50 displayed on the output unit 33 of the operator terminal 30.

The operator terminal 30 is initiated by the operator X1, and when a program for executing remote control of the moving body 22 is initiated, for example, the display screen 60A is displayed on the output unit 33.

The display screen 60A includes an input field 60A1 for a login Identification (ID) of the operator X1, an input field 60A2 for a password, and a login button 60A3. The operator X1 inputs a login ID such as a mail address of the operator X1 to the input field 60A1, inputs a password to the input field 60A2 for the password, and then operates the login button 60A3. The control unit 15 of the information processing device 10 executes a program for executing remote control and permits login when the input login ID and password pair coincide with a preset pair, and outputs display screen information of a next display screen 60B (refer to FIG. 8B) to the operator terminal 30.

FIG. 8B is a schematic diagram of an example of the display screen 60B. The display screen 60B is an example of the display screen 60 and the display screen 50 displayed on the output unit 33 of the operator terminal 30.

The display screen 60B is displayed on the output unit 33 when login to the operator X1 is permitted.

The display screen 60B includes a list 60B1 of remote control bases for the operator X1 and a button image 60B2 for receiving a transition instruction to the next display screen 60. The operator X1 selects, from the list 60B1 of remote control bases, one or a plurality of bases targeted for his remote control, and operates the button image 60B2. The control unit 15 of the information processing device 10 outputs to the operator terminal 30 display screen information of a display screen 60C (refer to FIG. 8C), on the moving body 22 present at the base targeted for remote control, which is received via the display screen 60B.

FIG. 8C is a schematic diagram of an example of the display screen 60C. The display screen 60C is an example of the display screen 60 and the display screen 50 displayed on the output unit 33 of the operator terminal 30.

When the button image 60B2 is operated on the display screen 60B (FIG. 8B), the output control unit 35B outputs the display screen 60C to the output unit 33. The display screen 60C is the display screen 60 on which information received via the display screen 60B about the moving body 22 present at the base targeted for remote control is superimposed on the map image M.

On the display screen 60C, images indicating the position P of each of one or a plurality of moving bodies 22 targeted for remote control by the operator X1, and each of the target position C, the target area Q, and the traveling path R are superimposed on the map image M. For example, the image indicating the position P of the moving body 22 is indicated by an image such as an arrow indicating the traveling direction of the moving body 22.

In addition, the display screen 60C includes alert information 60C2 indicating an alarm, a warning, or an operation request to the operator X1 generated in each of the plurality of moving bodies 22. The alert information is information indicating a response request to the operator X1 of the moving body 22. The alert information is, for example, a caution alert, an emergency alert that indicates a more urgent response request than caution alert, or the like. When an alert event occurs, notifying the moving body 22 of a caution alert or an emergency alert, the output control unit 15C of the information processing device 10 may output display screen information including the moving body ID of the moving body 22 where the alert event has occurred and alert information indicating the alert event of the moving body 22 to the operator terminal 30.

In addition, the display screen 60C includes a list 60C1 of a plurality of moving bodies 22 targeted for remote control by the operator X1. In addition, the display screen 60C includes a button image 60C3 for receiving a transition instruction to the next display screen 60. When the operator X1 operates the button image 60C3 to receive a transition instruction of the next display screen 60, the output control unit 15C of the information processing device 10 outputs display screen information for displaying a display screen 60D (see FIG. 8D), which is a video monitoring screen, to the operator terminal 30.

FIG. 8D is a schematic diagram of an example of the display screen 60D. The display screen 60D is an example of the display screen 60 and the display screen 50 displayed on the output unit 33 of the operator terminal 30.

When the button image 60C3 is operated on the display screen 60C (FIG. 8C), the output control unit 35B outputs the display screen 60D to the output unit 33. The display screen 60D is the display screen 60 including the captured video V of the surroundings of the moving body 22 targeted for remote control.

The display screen 60D displays a list 60D1 of a plurality of moving bodies 22 targeted for remote control by the operator X1. Alert information 60D2 is displayed in a display field of the moving body 22 which is included in the list 60D1 of moving bodies 22 and in which the alert event occurs. In addition, when the alert event occurs in the moving body 22 not included in the display screen 60D, the output control unit 35B performs an alert display 60D3 indicating that there is the moving body 22 where the alert event occurs outside the screen.

In addition, the display screen 60D includes, for each moving body 22 targeted for remote control, the captured video V of the surroundings of the moving body 22, a display field 60D4 indicating the moving body ID and communication state details of the moving body 22, a display field 60D5 indicating the traveling direction and the traveling path R of the moving body 22 and the target position C and target area Q, a traveling state 60D6 of the moving body 22, a communication delay time 60D7, a moving body state 60D8, alert information 60D9, and a display area 60D10 for a remote operation screen transition button and a mute button. In addition, by operating the display area of the traveling state 60D6 of the moving body 22, the operator X1 is able to give the moving body 22 traveling instructions. Therefore, the operator X1 can remotely control the moving body 22 by performing an operation such as touching a part of the display screen 60 without taking their eyes off from the captured video V.

The output control unit 35B preferably places each captured video V of the moving body 22 in a center portion that is an area other than an end of the display screen 60D. In addition, the output control unit 35B preferably places the display field 60D4 indicating the moving body ID and the communication state details of the moving body 22 as detailed information of the moving body 22 at an end of an upper portion of the display screen 60D. In addition, the output control unit 35B preferably places important information such as the alert information 60D9 or the like at a lower portion of the display area of each moving body 22.

The output control unit 35B may change the display color of the communication delay time 60D7 according to a value of the communication delay time. In addition, the arrangement of the display area of the moving body 22 displayed on the display screen 60D may be changeable according to the operation instruction of the input unit 32 by the operator X1 and the like. During the change operation, the control unit 35 may prohibit the screen transition of the display screen 60 and the remote control of the moving body 22.

FIG. 8E is a schematic diagram of an example of a display screen 60E. The display screen 60E is an example of the display screen 60 and the display screen 50 displayed on the output unit 33 of the operator terminal 30.

In the display screen 60D (FIG. 8D), when the display area 60D10 of the remote operation screen transition button is operated, the output control unit 35B outputs, to the output unit 33, the display screen 60E for remote control of the moving body 22 displayed in the display area where the display area 60D10 of the remote operation screen transition button is placed. The display screen 60E is the display screen 60 displayed at the time of executing remote control by the operator X1.

The captured video V of the surroundings of the moving body 22 targeted for remote control selected by the operator X1 is displayed on the display screen 60E. The traveling path R and the vehicle width guide G are superimposed on the captured video V.

In addition, the display screen 60E includes a display field 60E1 indicating the moving body ID and the communication state details of the moving body 22, an emergency stop button 60E2 for instructing an emergency stop of the moving body 22, and a display field 60E3 indicating the traveling direction, the traveling path R, the target position C and the target area Q of the moving body 22.

In addition, the display screen 60E displays a moving body state 60E4, an image 60E5 indicating a brake step-in amount of the moving body 22, an image 60E6 indicating a steering angle of the moving body 22, alert information 60E7, a vehicle speed 60E8 of the moving body 22, an accelerator step-in amount 60E9 of the moving body 22, a call button 60E10, and a controller connection status 60E11.

FIGS. 8F and 8G are enlarged schematic diagrams of an image indicating the accelerator step-in amount 60E9 of the moving body 22 illustrated in FIG. 8E. FIG. 8F illustrates an example of displaying the accelerator step-in amount and an amount obtained by converting the vehicle speed into the accelerator step-in amount. FIG. 8G illustrates an example of displaying the accelerator step-in amount as it is. The output control unit 35B displays images (60E9a, 60E9b) indicating an accelerator amount input to the moving body 22 in a display form corresponding to the magnitude of the accelerator step-in amount of the moving body 22.

FIG. 8H is an enlarged schematic diagram of the image 60E5 indicating a brake step-in amount of the moving body 22 illustrated in FIG. 8E. The output control unit 35B displays the image 60E5 indicating a step-in amount indicated by a brake step-in amount sensing sensor of the moving body 22.

FIGS. 8I and 8J are enlarged schematics of an image 60E6 indicating the steering angle of the moving body 22 illustrated in FIG. 8E. The output control unit 35B displays, for example, an icon image of a steering wheel indicating the steering angle of the moving body 22 in such a form that an opening indicating a portion of the steering wheel is rotated in a direction and at an angle corresponding to the steering direction and steering angle to display images 60E6a and 60E6b indicating the steering angle of the moving body 22. FIG. 8J illustrates an image indicating a state in which the steering wheel in the state of FIG. 8I is rotated to the right.

Turning back to FIG. 8E, the description continues. While visually checking the display screen 60E, the operator X1 operates the input unit 32 to remotely control the moving body 22. In detail, the remote operation control unit 35C of the operator terminal 30 transmits remote operation information corresponding to the operation instruction input to the moving body 22 according to the operation on the input unit 32 by the operator X1 to the information processing device 10 together with the moving body ID of the moving body 22. The information processing device 10 transmits the remote operation information to the moving body 22 identified by the moving body ID. The moving body 22 controls the driving unit 22B based on the remote operation information to move the moving body 22 according to the remote operation by the operator X1. Therefore, the moving body 22 is remotely operated by the operator X1 operating the operator terminal 30.

In addition, the output control unit 35B may output the display screen 60 in which the captured video V is disposed according to the vehicle type of the moving body 22 to the output unit 33 during remote control of the moving body 22 by the operator X1. The output control unit 15C of the information processing device 10 may output the display image information that further includes the vehicle type of the moving body 22 to the operator terminal 30.

FIG. 8K is a schematic diagram of an example of a display screen 60K when the moving body 22 is a small robot. The display screen 60K is an example of the display screen 60 and the display screen 50.

When the moving body 22 is a small robot, for example, the output control unit 35B places the map image M and the rear video V2 on an upper portion of the display screen 60K, the front video V1 on a center portion of the display screen 60K, and the left video V3 and the right video V4 on the left and right sides of the front video V1, respectively. In addition, the display screen 60K may be configured not to include the map image M.

FIG. 8L is a schematic diagram of an example of a display screen 60L when the moving body 22 is a towing truck. The display screen 60L is an example of the display screen 60 and the display screen 50.

When the moving body 22 is a towing truck, for example, the output control unit 35B places the map image M, a front bird's-eye view video V5 and the rear video V2 on an upper portion of the display screen 60L, the front video V1 on a center portion of the display screen 60L, and the left video V3 and the right video V4 on the left and right sides of the front video V1, respectively. The front bird's-eye view video V5 is a captured video V of the front of the moving body 22 taken from above the installation position of the imaging unit 26 in the moving body 22. The front bird's-eye view video V5 may be generated by the information processing device 10 or the operator terminal 30 by a known method using the captured video V. In addition, the display screen 60L may be a form that does not include the map image M. In addition, the output control unit 35B may display the front bird's-eye view video V5 and a rear bird's-eye view video in a switchable manner. The rear bird's-eye view video is a captured video V of the rear of the moving body 22 taken from above the installation position of the imaging unit 26 in the moving body 22. The rear bird's-eye view video may be generated by the information processing device 10 or the operator terminal 30 by a known method using the captured video V.

FIG. 8M is a schematic diagram of an example of a display screen 60M when the moving body 22 is a large towing truck. The display screen 60M is an example of the display screen 60 and the display screen 50.

When the moving body 22 is a large towing truck, the output control unit 35B places, for example, the map image M and the rear video V2 on an upper portion of the display screen 60M. In addition, the output control unit 35B places the front video V1 on the center portion of the display screen 60L, and places the left video V3 and a left-rear video V3b in a vertical arrangement on the left side of the front video V1. In addition, the output control unit 35B places the right video V4 and a right-rear video V4b in a vertical arrangement on the right side of the front video V1. In addition, the display screen 60M may be a form that does not include the map image M. In addition, the output control unit 35B may also reverse the vertical arrangement relationship of the left video V3 and the left-rear video V3b compared to the form illustrated in FIG. 8M. Likewise, the output control unit 35B may reverse the vertical arrangement relationship of the right video V4 and the right-rear video V4b compared to the form illustrated in FIG. 8M.

FIG. 8N is a schematic diagram of an example of another display screen 60N when the moving body 22 is a large towing truck. The display screen 60N is an example of the display screen 60 and the display screen 50.

When the moving body 22 is a large towing truck, the output control unit 35B places, for example, the map image M, the front bird's-eye view video V5, and the rear video V2 on an upper portion of the display screen 60N. In addition, the output control unit 35B places the front video V1 on the center portion of the display screen 60N, and places the left video V3 and the left-rear video V3b in a vertical arrangement on the left side of the front video V1. In addition, the output control unit 35B places the right video V4 and the right-rear video V4b in a vertical arrangement on the right side of the front video V1. In addition, the display screen 60N may be a form that does not include the map image M. In addition, the output control unit 35B may also reverse the vertical arrangement relationship of the left video V3 and the left-rear video V3b compared to the form illustrated in FIG. 8N. Likewise, the output control unit 35B may reverse the vertical arrangement relationship of the right video V4 and the right-rear video V4b compared to the form illustrated in FIG. 8N.

FIG. 8O is a schematic diagram of an example of another display screen 60O when the moving body 22 is a small robot. The display screen 60O is an example of the display screen 60 and the display screen 50.

When the moving body 22 is a small robot, the output control unit 35B places, for example, the map image M and the rear video V2 on an upper portion of the display screen 60O. In addition, the output control unit 35B places the front video V1 on the center portion of the display screen 60O. In addition, the output control unit 35B may display a rear bird's-eye view video V6 and the front bird's-eye view video V5 in a switchable manner.

FIG. 8P is a schematic diagram of an example of another display screen 60P when the moving body 22 is a large towing truck. The display screen 60P is an example of the display screen 60 and the display screen 50.

When the moving body 22 is a large towing truck, the output control unit 35B places, for example, the map image M, the front bird's-eye view video V5, the rear video V2, and an in-vehicle video V7 on an upper portion of the display screen 60P. The in-vehicle video V7 is a captured video V taken by the imaging unit 26 capturing the inside of the moving body 22. For example, the in-vehicle video V7 is a captured video V obtained by capturing the driver's seat of the moving body 22.

In addition, the output control unit 35B places the front video V1 on the center portion of the display screen 60P, and places the left video V3 and the left-rear video V3b in a vertical arrangement on the left side of the front video V1. In addition, the output control unit 35B places the right video V4 and the right-rear video V4b in a vertical arrangement on the right side of the front video V1. In addition, the display screen 60P may be a form that does not include the map image M. In addition, the output control unit 35B may also reverse the vertical arrangement relationship of the left video V3 and the left-rear video V3b compared to the form illustrated in FIG. 8P. Likewise, the output control unit 35B may reverse the vertical arrangement relationship of the right video V4 and the right-rear video V4b compared to the form illustrated in FIG. 8P.

FIG. 8Q is a schematic diagram of an example of another display screen 60Q when the moving body 22 is a large towing truck. The display screen 60Q is an example of the display screen 60 and the display screen 50.

When the moving body 22 is a large towing truck, the output control unit 35B places, for example, the map image M, the front bird's-eye view video V5, the rear video V2, and an in-vehicle video V7 on an upper portion of the display screen 60Q. In addition, the output control unit 35B places the front video V1 on the center portion of the display screen 60Q and places the left video V3 on the left side of the front video V1. In addition, the output control unit 35B places the right video V4 on the right side of the front video V1. In addition, the display screen 60Q may be a form that does not include the map image M. In addition, the output control unit 35B may change and display the lateral display positions of the front bird's-eye view video V5, the rear bird's-eye view video V6, and the in-vehicle video V7.

FIG. 8R is a schematic diagram of an example of a display screen 60R when the moving body 22 is a specific type of vehicle. The display screen 60R is an example of the display screen 60 and the display screen 50.

When the moving body 22 is a specific type of vehicle, or regardless of the vehicle type of the moving body 22, the output control unit 35B may display the display screen 60R. The output control unit 35B places, for example, the left video V3, the rear video V2, and the right video V4 on an upper portion of the display screen 60R. In addition, the output control unit 35B maximizes and places the front video V1 on the center portion of the display screen 60R.

FIG. 8S is a schematic diagram of an example of a display screen 60S. The display screen 60S is an example of the display screen 60 and the display screen 50.

The output control unit 35B may display the map image M on the left side of the display screen 60S, and display the display screen 60S on the right side of the display screen 60S, in which a display area obtained by removing the map image M from any of the display screens 60 (the display screens 60K to 60R) of FIGS. 8K to 8R is placed.

### Third Modification

In the present modification, the display screen 50 output to the output unit 33 of the operator terminal 30 during remote control of the moving body 22 by the operator X1 will be described in detail. In the present modification, the display screen 50 output to the output unit 33 of the operator terminal 30 will be referred to as a display screen 70 in the following description. The display screen 70 is an example of the display screen 50.

As described in the embodiment described above, the output control unit 35B of the operator terminal 30 outputs, to the output unit 33, the display screen 70 indicated by the display screen information received from the information processing device 10.

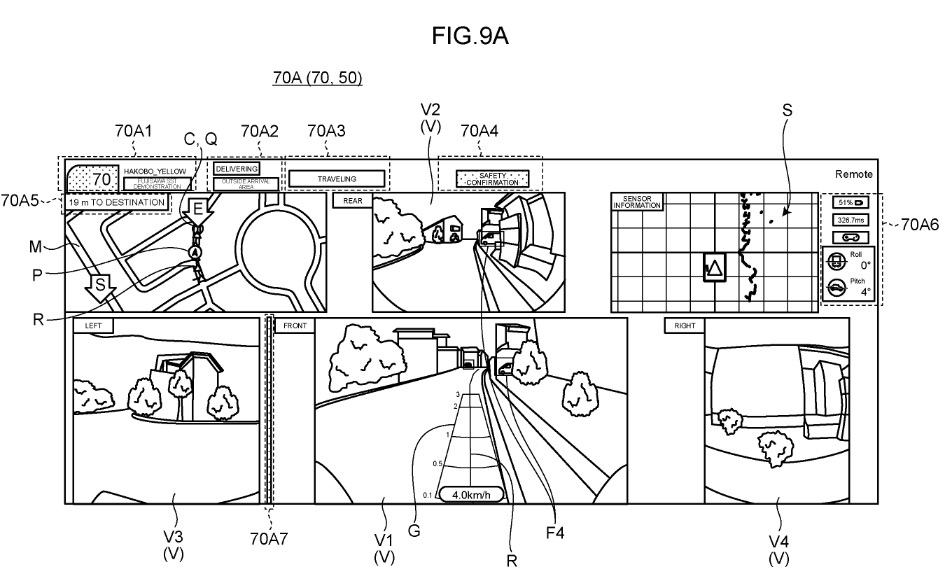

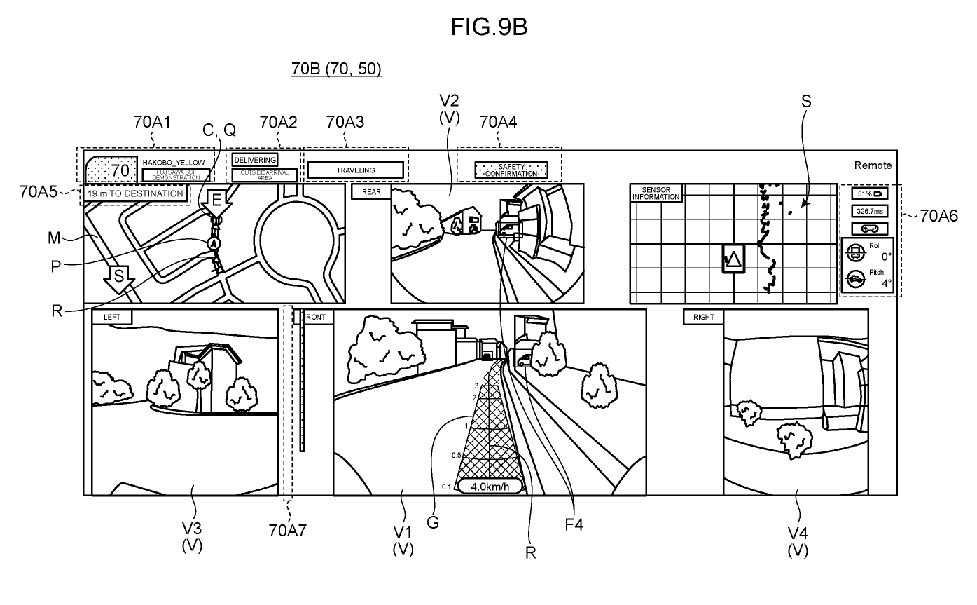

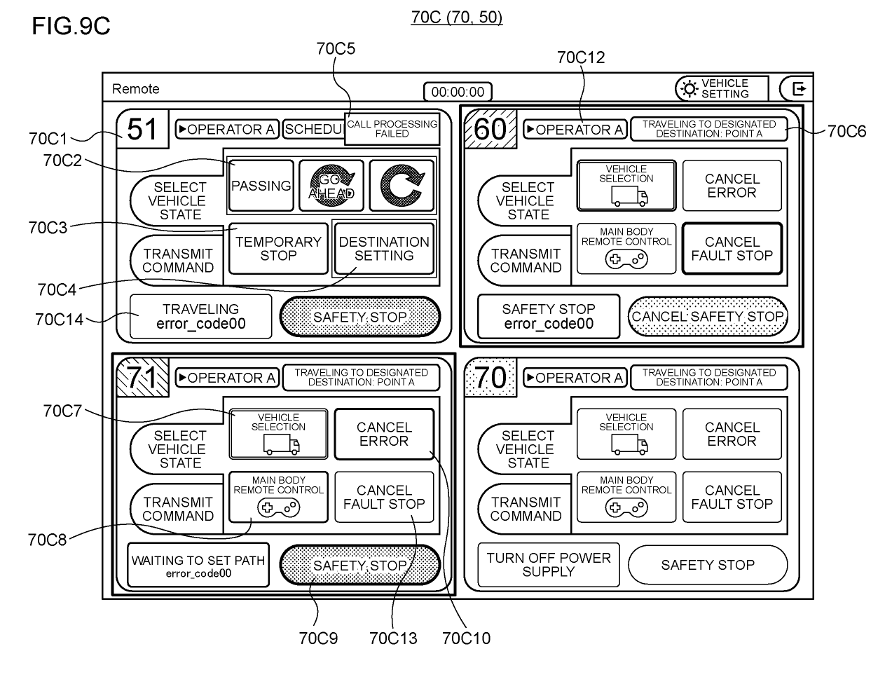

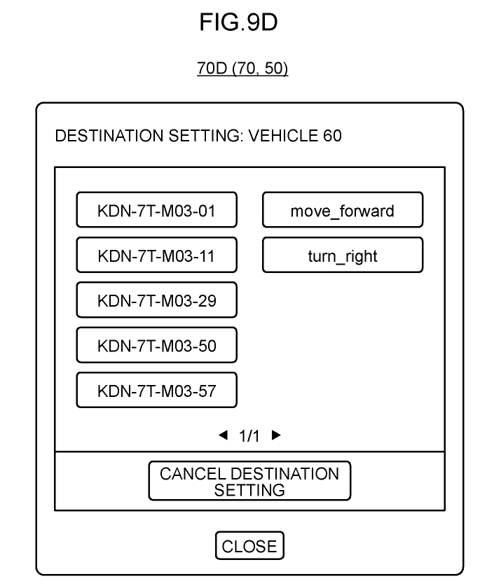

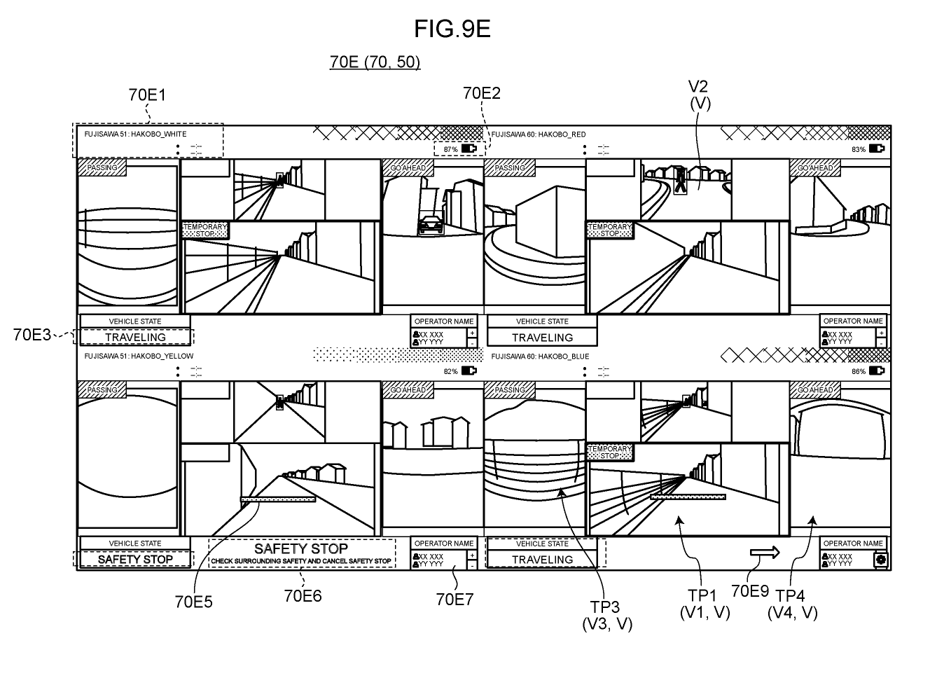

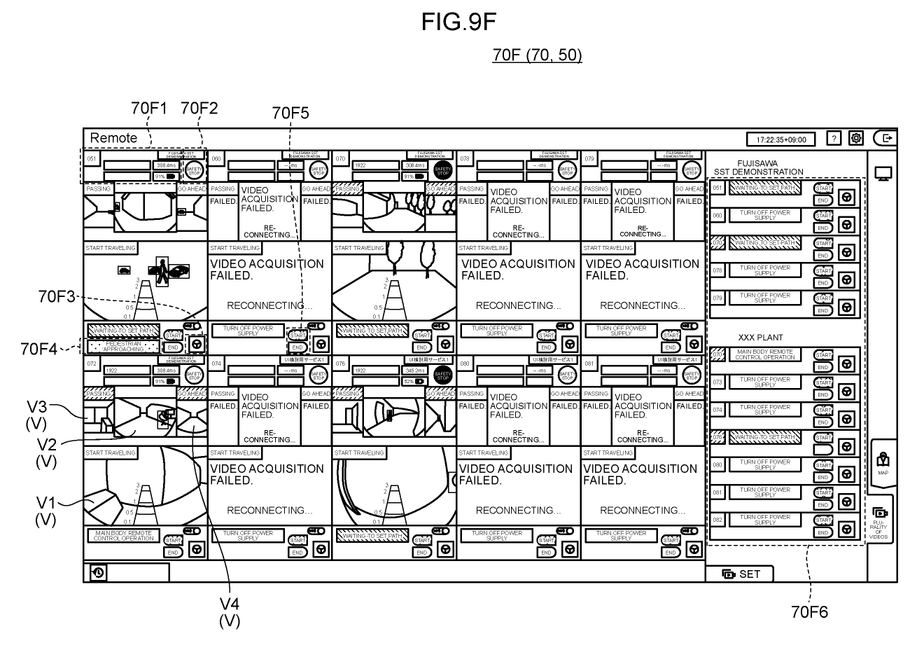

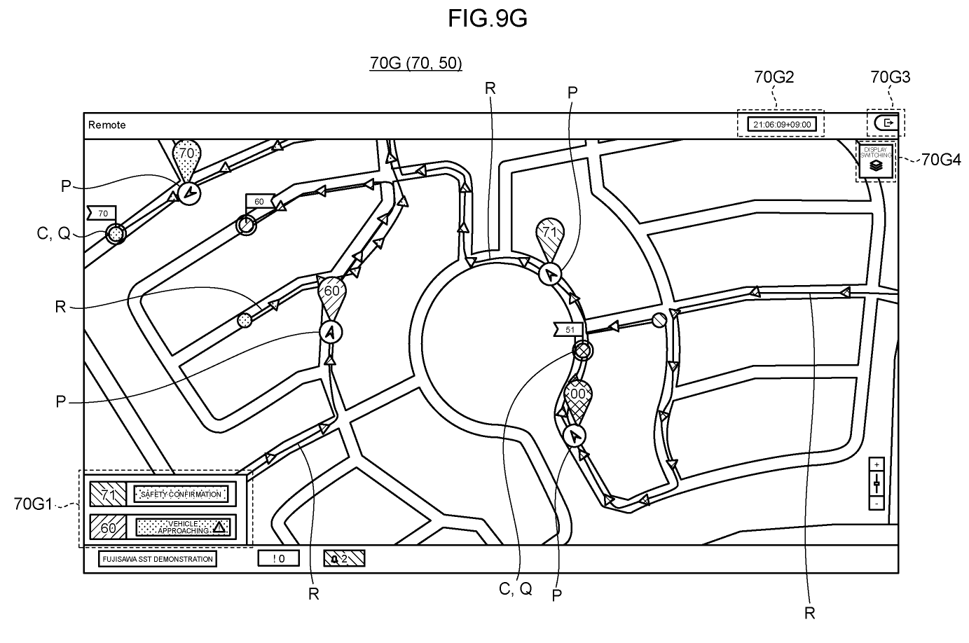

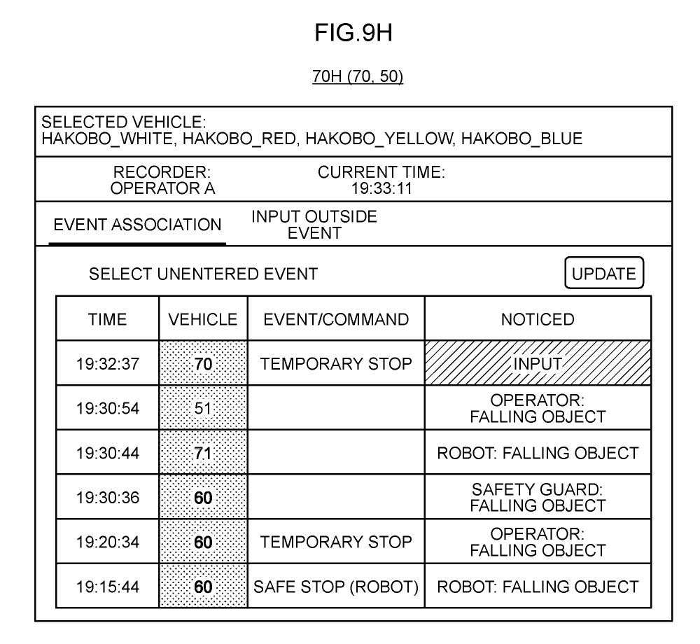

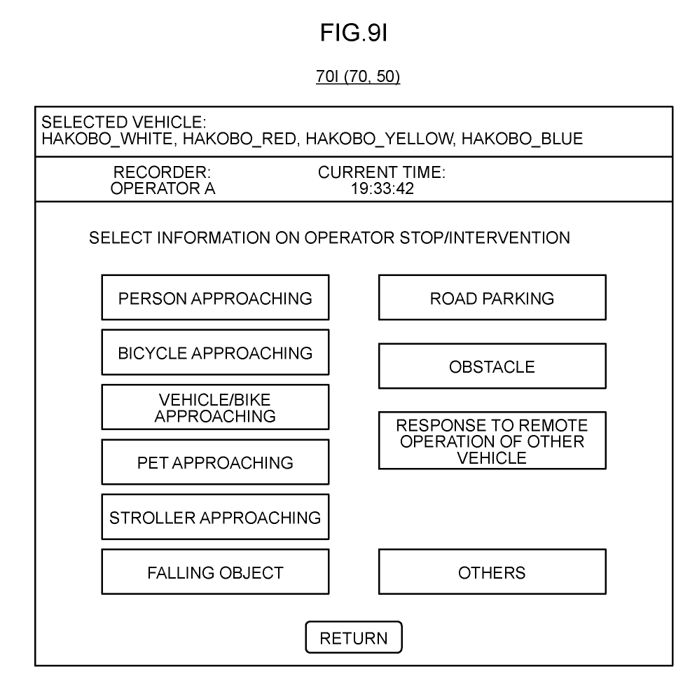

FIG. 9A is a schematic diagram of an example of a display screen 70A. The display screen 70A is an example of the display screen 70 and the display screen 50 displayed on the output unit 33 of the operator terminal 30.

FIG. 9A is an example of the display screen 70A displayed on the output unit 33 during remote control of the moving body 22 by the operator X1. The display screen 70A is an example of the display screen 50.

The captured video V (front video V1, rear video V2, left video V3, right video V4) of the surroundings of the moving body 22 targeted for remote control is displayed on the display screen 70A. The traveling path R and the vehicle width guide G are superimposed on the captured video V. In addition, the detection frame F4 indicating object detection is superimposed on the captured video V in an area of the object detected by the sensor 22A appearing in the captured video V.

The moving body ID of the moving body 22, a name of the moving body 22, and information 70A1 indicating a traveling area of the moving body 22 are displayed on an upper portion of the display screen 70A. A moving body state 70A2, a vehicle status 70A3, and alert information 70A4 of the moving body 22 are displayed on the upper portion of the display screen 70A.

An image indicating the positional relationship between various types of objects present around the moving body 22 and the moving body 22 and sensor-related information 70A6 indicated by the sensing result S are displayed on the right side of the display screen 70A.

Images indicating each of the target position C, the position P of the moving body 22, the target area Q, and the traveling path R are superimposed on the map image M of the map data as in the embodiment described above. In addition, remaining distance information 70A5 indicating the remaining distance from the position P of the moving body 22 to the target position C is displayed on the display screen 70A.

On a left or right side of the display area of the front video V1 corresponding to a lane change direction indicated by a turn signal of the moving body 22, an image 70A7 indicating that the turn signal for the lane change in that direction is blinking on the moving body 22 is displayed.

FIG. 9B is an example of a display screen 70B displayed on the output unit 33 during remote control of the moving body 22 by the operator X1. The display screen 70B is an example of the display screen 50.

The display screen 70B is the same as the display screen 70A except for the difference in the display form of the traveling path R. The image indicating the traveling path R may be linear as illustrated in FIG. 9A, but may be a band shape with a width corresponding to the vehicle width of the moving body 22, as illustrated in FIG. 9B.

FIG. 9C is a schematic diagram of an example of a display screen 70C displayed on the output unit 33 during remote control of the moving body 22 by the operator X1. The display screen 70C is an example of the display screen 70 and the display screen 50.

The display screen 70C includes a display area for each of the moving bodies 22 targeted for remote control by the operator X1. In the display area for each moving body 22, a moving body ID 70C1 of the moving body 22 is displayed in a display color corresponding to the color of the moving body 22. The display screen 70C includes an instruction button 70C2 for instructing a sound to be output from the moving body 22. The operator X1 operates the instruction button 70C2 to output a sound indicated by sound information associated with the instruction button 70C2 from a speaker of the moving body 22.

In addition, the display screen 70C includes a temporary stop button 70C3, a destination setting button 70C4, and an error message display area 70C5.

The temporary stop button 70C3 is an image area operated by the operator X1 when temporarily stopping the movement of the moving body 22. The destination setting button 70C4 is an image area operated by the operator X1 when setting the target position C of the moving body 22. When the display area of the destination setting button 70C4 is operated by the operator X1, the output control unit 35B displays a display screen 70D illustrated in FIG. 9D on the output unit 33.

FIG. 9D is a schematic diagram of an example of the display screen 70D. The display screen 70D is an example of the display screen 70 and the display screen 50. The display screen 70D displays, for example, a list of target positions C registered in the target position management DB 14C. The operator X1 may select a desired target position C to set the next target position C of the moving body 22. In addition, the operator X1 may operate a destination setting cancel button included in the display screen 70D to cancel the currently set target position C.

Turning back to FIG. 9C, the description continues. The error message display area 70C5 displays error contents when an error occurs due to the operation on any display area included in the display screen 70C by the operator X1.

In addition, a name 70C12 of the operator X1, a traveling status 70C6 of the moving body 22, a safety stop cancel button 70C9, and a vehicle status 70C14 of the moving body 22 are displayed on the display screen 70C. The traveling status 70C6 of the moving body 22 is information indicating, for example, a point where the moving body 22 is traveling, whether the moving body 22 is traveling, and the like. The vehicle status 70C14 of the moving body 22 is information indicating a movement state. When the movement state of the moving body 22 is an error, an error code and an error content are displayed in a display field of the vehicle status 70C14 of the moving body 22. The safety stop cancel button 70C9 is an image area operated by the operator X1 when instructing the moving body 22 to safely stop, or to cancel the safe stop state of the moving body 22.

In addition, the display screen 70C includes a vehicle selection button 70C7, a main body remote control button 70C8, an error cancel button 70C10, and a fault stop cancel button 70C13. The vehicle selection button 70C7 is a button image area operated by the operator X1 when starting a remote operation of the moving body 22. The main body remote control button 70C8 is a button image area operated by the operator X1 when the moving body 22 is made operable by a remote control provided on the moving body 22. The error cancel button 70C10 is a button image area operated by the operator X1 when clearing an error occurred in the moving body 22. The fault stop cancel button 70C13 is a button image operated by the operator X1 when canceling the stop state caused due to a fault in the moving body 22, and can be operated when the moving body 22 is stopped due to a fault.

FIG. 9E is a schematic diagram of an example of a display screen 70E. The display screen 70E is an example of the display screen 70 and the display screen 50 displayed on the output unit 33 of the operator terminal 30.

The captured video V (front video V1, rear video V2, left video V3, right video V4) for each of a plurality of moving bodies 22 targeted for remote control is displayed on the display screen 70E. In addition, in the display area of each moving body 22, a display field 70E1 for the traveling area and the moving body ID, a display field 70E2 for the target position C, a display field 70E3 for the moving body state, a display field 70E6 for the alert information, and a display field 70E7 for the name of the operator X1 are provided around the display area of the captured video V. In addition, the display areas of each of the front video V1, the rear video V2, the left video V3, and the right video V4 as captured video V for each moving body 22 are associated with corresponding executable processing so that various types of processing can be executed by operating them.

For example, when the operator X1 operates a display field TP3 of the left video V3, the operator terminal 30 outputs remote operation information including a first standard sound output instruction for the moving body 22 corresponding to the display field to the moving body 22 via the information processing device 10. In this case, a first standard sound is outputted from the speaker of the moving body 22. For example, when the operator X1 operates a display field TP4 of the right video V4, the operator terminal 30 outputs remote operation information including a second standard sound output instruction from the moving body 22 corresponding to the display field to the moving body 22 via the information processing device 10. In this case, a second standard sound is outputted from the speaker of the moving body 22. In addition, for example, when the operator X1 operates a display field TP1 of the front video V1, the operator terminal 30 outputs remote operation information including temporary stop or restart of traveling to the moving body 22 corresponding to the display field to the information processing device 10. In such a case, the remote operation information is transmitted from the information processing device 10 to the moving body 22 such that the moving body 22 is remotely operated to temporarily stop or resume traveling.

In addition, a display field 70E9 indicating the state of the turn signal of the moving body 22 may be included in the display field of each moving body 22. In addition, a reference line 70E5 indicating a reference for the distance from the moving body 22 may be superimposed on the captured video V included in the display field of each moving body 22.

FIG. 9F is a schematic diagram of an example of a display screen 70F. The display screen 70F is an example of the display screen 70 and the display screen 50 displayed on the output unit 33 of the operator terminal 30.

The captured video V (front video V1, rear video V2, left video V3, right video V4) for each of a plurality of moving bodies 22 targeted for remote control is displayed on the display screen 70F. In addition, in the display area of each moving body 22, a display field 70F1 for the traveling area of the moving body 22, the moving body ID, the moving body state of the moving body 22, and the communication delay of the moving body 22 is provided around the display area of the captured video V. In addition, in the display area of each moving body 22, an emergency stop button 70F2 for instructing an emergency stop of the moving body 22, and a start/end button 70F5 for instructing the start or end of remote control of the moving body 22 are provided around the display area of the captured video V. The operator X1 can operate the emergency stop button 70F2 to urgently stop the moving body 22. In addition, the operator X1 can start or end the remote operation of the moving body 22 (the travel instruction to the moving body 22) by operating the start/end button 70F5. In addition, in the present description, the remote operation means both the travel instruction to the moving body 22 and the remote control using a steering wheel/accelerator/brake and the like.

In addition, a display field 70F4 of alert information and a remote operation screen transition instruction button 70F3 are displayed around the display area of the captured video V in the display area of each moving body 22 of the display screen 70F. When the operator X1 operates the remote operation screen transition instruction button 70F3 of the desired moving body 22, the output control unit 35B may display, on the output unit 33, the display screen 70 of the display screen 70A or the display screen 70B (see FIGS. 9A and 9B) that is displayed when the moving body 22 is remotely operated.

In addition, list information 70F6 of each of the plurality of moving bodies 22 targeted for remote control by the operator X1 is displayed on the display screen 70F. The output control unit 35B may group information on each of the moving bodies 22 for each traveling area where the moving bodies 22 travel, and then display the list information 70F6 of the moving bodies 22 on the display screen 70F.

FIG. 9G is a schematic diagram of an example of a display screen 70G. The display screen 70G is an example of the display screen 70 and the display screen 50.

The display screen 70G is the display screen 70 on which the information on the plurality of moving bodies 22 targeted for remote control by the operator X1 is superimposed on the map image M.

On the display screen 70G, images indicating the position P of each of one or the plurality of moving bodies 22 targeted for remote control by the operator X1, and each of the target position C, the target area Q, and the traveling path R are superimposed and displayed on the map image M. For example, the image indicating the position P of the moving body 22 is indicated by an image such as an arrow indicating the traveling direction of the moving body 22. In addition, the traveling path R is indicated by a line image with an arrow indicating the traveling direction of the moving body 22.

In addition, the display screen 70G includes alert information 70G1 indicating an alarm or a warning occurring in each of the plurality of moving bodies 22.

In addition, the display screen 70G includes a current time 70G2, a logout button 70G3 operated at the time of logout, and a display switching button 70G4 for receiving a switching instruction to another display screen 70. In addition, the display screen 70G may further include the travel position of the moving body 22 and the number of currently occurring alert information.

FIGS. 9H and 9I are schematic diagrams of an example of a display screen 70H and a display screen 70I. The display screen 70H and the display screen 70I are examples of the display screen 70 and the display screen 50.

The display screen 70H is an input screen for the operator X1 to input memo information to the moving body 22. The worker X2 may operate the input unit 32 to input information, error contents, error factors and the like, noticed during remote control and the like, for each moving body 22 via the display screen 70H. In addition, the output control unit 35B may further display the display screen 70I for selecting the error content. The operator X1 may select a desired error content from a list of error contents displayed on the display screen 70I to input the memo information for each moving body 22.

The control unit 35 of the operator terminal 30 receiving the input of memo information to the moving body 22 outputs the received memo information, the moving body ID of the moving body 22 corresponding to the memo information, and an event (alert) generated in the moving body 22 (e.g., safety confirmation request/vehicle approach/remote operation switching/emergency stop and the like) to the information processing device 10 in association with each other. In the information processing device 10, the memo information and the event may be stored in association with the received moving body ID of the moving body 22 for each moving body 22.

Next, an example of a hardware configuration of the information processing device 10, the moving body 22, the operator terminal 30, and the worker terminal 40 of the embodiments and the modifications described above will be described.

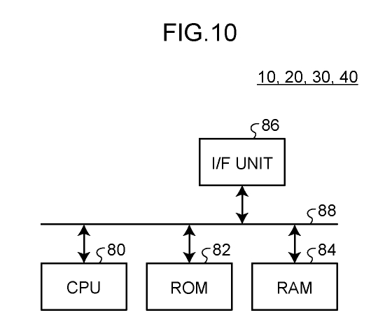

FIG. 10 is a diagram illustrating a hardware configuration of an example of the information processing device 10, the moving body 22, the operator terminal 30, and the worker terminal 40 of the embodiments and modifications described above.

The information processing device 10, the moving body 22, the operator terminal 30, and the worker terminal 40 in the embodiments and modifications described above have a hardware configuration that utilizes a related computer, with a central processing unit (CPU) 80, a read only memory (ROM) 82, a random access memory (RAM) 84, and an I/F unit 86 and the like, connected to each other via a bus 88.

The CPU 80 is an arithmetic unit that controls the information processing device 10, the moving body 22, the operator terminal 30, and the worker terminal 40 of the embodiments and modifications described above. The ROM 82 stores programs or the like for implementing information processing by the CPU 80. The RAM 84 stores data necessary for various processing by the CPU 80. The I/F unit 86 is an interface for transmitting and receiving data and is connected to a storage unit, an input unit, an output unit, a sensor, a communication unit, and the like.

In the information processing device 10, the moving body 22, the operator terminal 30, and the worker terminal 40 of the embodiments and modifications described above, the CPU 80 reads the program from the ROM 82 onto the RAM 84 and executes the same, and each functional unit is implemented on the computer.

In addition, the programs for executing the processing executed by the information processing device 10, the moving body 22, the operator terminal 30, and the worker terminal 40 of the embodiments and modifications described above may be stored in a hard disk drive (HDD). In addition, the programs for executing the processing executed by the information processing device 10, the moving body 22, the operator terminal 30, and the worker terminal 40 of the embodiments and modifications described above may be incorporated and provided in the ROM 82 in advance.

In addition, the programs for executing the processing executed by the information processing device 10, the moving body 22, the operator terminal 30, and the worker terminal 40 of the embodiments and modifications described above may be stored as a file in an installable format or an executable format in a computer-readable storage medium such as a CD-ROM, a CD-R, a memory card, a digital versatile disk (DVD), or a flexible disk (FD) and provided as a computer program product. In addition, the programs for executing the information processing executed by the information processing device 10, the moving body 22, the operator terminal 30, and the worker terminal 40 of the embodiments and modifications described above may be stored in a computer connected to a network such as the Internet and provided to be downloaded via the network. In addition, the programs for executing the information processing executed by the information processing device 10, the moving body 22, the operator terminal 30, and the worker terminal 40 of the embodiments and modifications described above may be provided or distributed via a network such as the Internet.

In addition, the technology can also take the following configuration.

### (1)

An information processing method executed by an information processing device, the information processing method including:

a receiving step of receiving moving body information including a position of a moving body; and

a determining step of determining that the moving body is positioned at a specific position when a specific determination condition that the position of the moving body is within a specific area that includes the specific position of the moving body is satisfied.

### (2)

The information processing method according to (1), wherein

the receiving step

receives the moving body information including the position of the moving body and a moving body state of the moving body, and

the determining step

determines that the moving body is positioned at the specific position when the specific determination condition that the position of the moving body is within the specific area and the moving body state indicates stop is satisfied.

### (3)

The information processing method according to (1) or (2), further including

an output control step of outputting a display screen indicating a positional relationship between the specific area and the moving body to an operator terminal of an operator remotely controlling the moving body.

### (4)

The information processing method according to (3), wherein

the output control step

outputs the display screen in a first display form to the operator terminal when the position of the moving body is within the specific area, and

outputting the display screen in a second display form to the operator terminal when the position of the moving body is outside the specific area.

### (5)

The information processing method according to (3) or (4), wherein

the output control step

outputs, to the operator terminal, the display screen on which an image indicating the position of the moving body and an image indicating the specific area are superimposed on at least one of a map image indicating a traveling environment of the moving body and a captured video of surroundings of the moving body.

### (6)

The information processing method according to any one of (3) to (5), wherein

the output control step

outputs, to the operator terminal, the display screen on which an image indicating a traveling path of the moving body is superimposed on at least one of a map image indicating a traveling environment of the moving body and a captured video of surroundings of the moving body.

### (7)

The information processing method according to any one of (3) to (6), wherein

the output control step

outputs, to the operator terminal, the display screen including remaining distance information indicating a remaining distance from the position of the moving body to the specific position.

### (8)

The information processing method according to any one of (3) to (7), wherein

the output control step

outputs information indicating that the moving body is positioned at the specific position to at least one of the operator terminal and a worker terminal of a worker performing a work using the moving body in a real space when it is determined that the moving body is positioned at the specific position.

### (9)

The information processing method according to any one of (3) to (8), wherein

the determining step re-determines whether the moving body is positioned at the specific position when the specific determination condition is satisfied and a specific determination instruction is received again from the operator terminal via the display screen.

### (10)

The information processing method according to any one of (1) to (9), wherein

the specific position is a target position of the moving body,

the specific area is a target area that includes the target position,

the specific determination condition is an arrival determination condition indicating that the position of the moving body is within the target area that includes the target position of the moving body, and

the determining step

determines that the moving body is positioned at the target position and has arrived at the target position when the position of the moving body satisfies the arrival determination condition.

### (11)

The information processing method according to any one of (1) to (10), wherein

the specific position is a departure position of the moving body,

the specific area is a departure area including the departure position,

the specific determination condition indicates that the position of the moving body is within the departure area including the departure position of the moving body, and

the determining step

determines that the moving body is positioned at the departure position, and outputs travel start request information to an operator terminal of an operator remotely managing the moving body when the position of the moving body satisfies the specific determination condition.

### (12)

The information processing method according to any one of (1) to (11), wherein

the specific area

is a circular area having a predetermined radius centered at the specific position in the real space.

### (13)

The information processing method according to any one of (1) to (12), wherein

the specific area is an area surrounding an object disposed at the specific position.

### (14)

An information processing program cause a computer to perform:

a receiving step of receiving moving body information including a position of a moving body; and

a determining step of determining that the moving body is positioned at a specific position when a specific determination condition that the position of the moving body is within a specific area that includes the specific position of the moving body is satisfied.

### (15)

An information processing device including:

a communication control unit configured to receive display screen information including moving body information including a position of a moving body, and information indicating a determination that a specific determination condition that the position of the moving body is within a specific area that includes a specific position of the moving body is satisfied, and the moving body is positioned at the specific position; and

an output control unit configured to output a display screen indicated by the display screen information to an output unit.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing method executed by an information processing device, the information processing method comprising:
receiving moving body information including a position of a moving body; and
determining that the moving body is positioned at a specific position when a specific determination condition that the position of the moving body is within a specific area that includes the specific position of the moving body is satisfied.

2. The information processing method according to claim 1, wherein
at the receiving
the moving body information including the position of the moving body and a moving body state of the moving body is received, and
at the determining
it is determined that the moving body is positioned at the specific position when the specific determination condition that the position of the moving body is within the specific area and the moving body state indicates stop is satisfied.

3. The information processing method according to claim 1, further comprising
outputting a display screen indicating a positional relationship between the specific area and the moving body to an operator terminal of an operator remotely controlling the moving body.

4. The information processing method according to claim 3, wherein
at the outputting
the display screen in a first display form is output to the operator terminal when the position of the moving body is within the specific area, and
the display screen in a second display form is output to the operator terminal when the position of the moving body is outside the specific area.

5. The information processing method according to claim 3, wherein
at the outputting
the display screen on which an image indicating the position of the moving body and an image indicating the specific area are superimposed on at least one of a map image indicating a traveling environment of the moving body and a captured video of surroundings of the moving body is output to the operator terminal.

6. The information processing method according to claim 3, wherein
at the outputting
the display screen on which an image indicating a traveling path of the moving body is superimposed on at least one of a map image indicating a traveling environment of the moving body and a captured video of surroundings of the moving body is output to the operator terminal.

7. The information processing method according to claim 3, wherein
at the outputting
the display screen including remaining distance information indicating a remaining distance from the position of the moving body to the specific position is output to the operator terminal.

8. The information processing method according to claim 3, wherein
at the outputting
information indicating that the moving body is positioned at the specific position to at least one of the operator terminal and a worker terminal of a worker performing a work using the moving body in a real space when it is determined that the moving body is positioned at the specific position is output.

9. The information processing method according to claim 3, wherein
at the determining, it is re-determined whether the moving body is positioned at the specific position when the specific determination condition is satisfied and a specific determination instruction is received again from the operator terminal via the display screen.

10. The information processing method according to claim 1, wherein
the specific position is a target position of the moving body,
the specific area is a target area that includes the target position,
the specific determination condition is an arrival determination condition indicating that the position of the moving body is within the target area that includes the target position of the moving body, and
at the determining
it is determined that the moving body is positioned at the target position and has arrived at the target position when the position of the moving body satisfies the arrival determination condition.

11. The information processing method according to claim 1, wherein
the specific position is a departure position of the moving body,
the specific area is a departure area including the departure position,
the specific determination condition indicates that the position of the moving body is within the departure area including the departure position of the moving body, and
at the determining
it is determined that the moving body is positioned at the departure position, and outputs travel start request information to an operator terminal of an operator remotely managing the moving body when the position of the moving body satisfies the specific determination condition.

12. The information processing method according to claim 1, wherein
the specific area
is a circular area having a predetermined radius centered at the specific position in the real space.

13. The information processing method according to claim 1, wherein
the specific area is an area surrounding an object disposed at the specific position.

14. A computer program product including programmed instructions embodied in and stored on a non-transitory computer readable medium, wherein the instructions, when executed by a computer, cause the computer to perform:
receiving moving body information including a position of a moving body; and
determining that the moving body is positioned at a specific position when a specific determination condition that the position of the moving body is within a specific area that includes the specific position of the moving body is satisfied.

15. An information processing device comprising:
a memory; and
a hardware processor coupled to the memory and configured to:
receive display screen information including moving body information including a position of a moving body, and information indicating a determination that a specific determination condition that the position of the moving body is within a specific area that includes a specific position of the moving body is satisfied, and the moving body is positioned at the specific position; and
output a display screen indicated by the display screen information to a display.
